(19) United States
(12) Patent Application Publication
(10) Pub. No.: US 2011/0060642 A1
(43) Pub. Date: Mar. 10, 2011

(54) CUSTOMIZABLE METHOD AND SYSTEM FOR THE AUTOMATIC MANAGEMENT AND EVALUATION OF BUSINESS LEAD CREATION AND DEVELOPMENT

(76) Inventors: Garry Davis, Indianapolis, IN (US); Daniel Mallinak, Indianapolis, IN (US)

(21) Appl. No.: 12/855,149

(22) Filed: Aug. 12, 2010

Related U.S. Application Data
(60) Provisional application No. 61/233,278, filed on Aug. 12, 2009.

(51) Int. Cl. G06Q 30/00

(52) U.S. Cl. 705/14.41

(57) ABSTRACT

A method for measuring the performance and utilization of a marketing campaign, including tracking responsiveness of a plurality of distribution channels to respective leads, wherein each respective distribution channel has at least one component, measuring a return on investment for a marketing campaign, managing the respective distribution channels, evaluating performance of the marketing campaign, and evaluating performance of the at least one components of the respective distribution channels on the leads. The marketing campaign includes at least one marketing event, the leads are attributed to the at least one marketing event, and the leads are associated with a voice of customer evaluation.

### TECHNICAL FIELD

The present novel technology relates generally to the field of computer science and, more particularly, to system for automatically managing and evaluating business leads.

### BACKGROUND

For companies selling goods and services in a one-step or multi-step distribution channel, sales are typically transacted via a distributor or some form of an intermediary. In these situations, a ‘buyer’ typically cannot purchase directly from the manufacturer. The common shorthand for these ‘business-to-distributor business’ models is B-to-D or B-to-D^{N}. The buyer must buy product from a distributor. This lack of direct contact between a ‘buyer’ and a manufacturer utilizing a one-step or multi-step distribution channel gives rise to many problems and complications for the manufacturer.

The lack of direct ‘buyer’ contact makes measuring the effectiveness of sales-generating activities extremely difficult, if not virtually impossible. Additionally, the lack of direct ‘buyer’ contact obfuscates both the influence of marketing campaigns and the effectiveness of advertising dollars spent to generate selling inquiries and to promote the brand. Further, the lack of direct ‘buyer’ contact dilutes or eliminates most, if not all, means for the manufacturer to receive customer feedback.

Further, the use of other parties to act as an intermediary or channel for the manufacturer's sales prevents the manufacturer from obtaining information on the effectiveness of the sales force of those other parties. For example, a manufacturer has no way of determining which salespersons of the manufacturer's distributor(s) are effective and which are not. Similarly, a manufacturer has no way to detect when members of a distributor's sales force are utilizing “bait-n-switch” schemes; a practice where a salesperson lures in a potential customer through promotion of the manufacturer's product only to sell a competitor's product.

Typically, when the sales force of a manufacturer using a one or two step distribution scheme is presented with a sales lead, the sales force will forward the lead with various information to a distributor sales representative. Often, the lead is forwarded to a distributor or to the distributor sales representative specifically due to the distributor sales representative's believed past performance. However, the distributor sales representative's believed past performance may vary greatly from the distributor sales representative's actual past performance. The potential variance between the believed and actual past performance can be traced to the lack of contact between the ‘buyer’ and the manufacturer during the sales process. Additionally, the lack of a measure of actual sales performance of a distributor sales representative makes any corrective measures speculative and probably irrational. Also, similar to the lack of a viable means of evaluating the performance of the members of a distributor's sales forces, there is no means by which a manufacturer can retract a sales lead once granted to a distributor. Simply stated, if the lead can't be tracked, it can't rationally be retracted.

Finally, the number of actors within the distribution channels, multiple layers insulating the manufacture from the ultimate purchaser and the like makes measuring ROI (Return on Investment) or other metrics for sales generation activities difficult, if not virtually impossible. The multi-layer aspect of the distribution channel also presents informational problems for management. There is a near vacuum of any reliable or meaningful information. The complexity of the information (multi-layered, within the organization, external to the organization, etc.) prevents meaningful analysis. Even where there is analysis, the underlining data often can't be packaged to permit more in-depth analysis.

Therefore, there is need for a method of tracking and managing the effectiveness of advertizing for sales lead generation and for the management of sales leads particularly though not limited to, B-to-D or B-to-D^{N} business environments. The present invention addresses this need.

### SUMMARY

The novel technology is set forth in the claims below, and the following is not in any way to limit, define or otherwise establish the scope of legal protection. In general terms, the present novel technology relates generally to an automatic method for the management of business leads and the evaluation of business professionals and their use of said business leads.

One object of the present novel technology is to provide an improved means to measure the ROI of advertising and sales lead generating activities. Further objects, embodiments, forms, benefits, aspects, features and advantages of the claimed technology may be obtained from the description, drawings, and claims provided herein.

### BRIEF DESCRIPTION OF THE DRAWINGS

FIG. 1 is an example process diagram of lead management.

FIG. 2 is an example of typical sales lead routing depicted in flow chart form.

FIG. 3 is an example of typical sales lead prioritization depicted in flow chart form.

FIG. 4 is a diagram of an example sales lead management process.

FIG. 5 is a diagram of an example trade show sales lead management process.

FIG. 6 is an example process diagram of sales lead management for an example international company.

FIG. 7 is an example of a typical sales lead routing.

FIG. X is a process flow diagram for one implementation illustrating the stages involved in implementing the customizable system for the automatic management and evaluation of business lead creation and development.

FIG. 8 is an example of a possible implementation of a default sales lead process.

FIG. 9 is an example of a possible custom sales lead router process.

FIG. 10 is a diagram of a possible custom sales lead management process.

FIG. 11 is a process flow diagram of an example installation of a customizable system for the automatic management and evaluation of business lead creation and development.

FIG. 12 is a diagrammatic view of a computer system of one implementation.

### DETAILED DESCRIPTION

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated novel technology and such further applications of the principles of the novel technology as illustrated therein being contemplated as would normally occur to one skilled in the art to which the novel technology relates.

The present novel technology provides a system and method for the measurement of the ROI of advertising and sales lead generating activities. The measurement of ROI for advertising and sales lead generating activities can be performed for not only for B to D situations but also for business to consumer environments, business to distributor(s) environments, business to distributor(s) to distributor(s) environments, and in hybrid business environments. The measurement of ROI is typically made in such a way as to apply both to campaign advertising and sales lead generation activities as well as for individual advertising and/or sales lead generation activities. Further, the measurement of ROI permits the detection and measurement of co-lateral ROI of past or concurrent advertising and/or sales lead generating activities. In one embodiment, the measurement of ROI is enabled through the unique identification and association of leads to sales generation activities. Typically, the ROI, along with other various performance measurements, is displayed in real time through the use of interactive dashboards and detailed reports.

Additionally, the measurement of ROI for advertising and/or sales generation activities can also be segmented by or attributed to the actions taken by sales agents during the course of fulfilling a sales lead. Furthermore, the ROI can be segmented across marketing events within a marketing campaign, across the media types of the marketing events, and across the respective venues of the media types.

For example, a manufacturer can properly attribute the portion of ROI enabled by the actions of a sales agent in response to sales leads created by the sales generation activity. The sales agent can be either internal or external to the manufacturer. Similarly, the present novel technology can also attribute the portion of ROI enabled by collective sales service providers. A collective sales service provider is a collection of sales actors that operate either individually or together to provide services beneficial to the fulfillment of sales opportunities. A collective sales service provider can be internal to the manufacturer, external to the manufacturer, or some combination of both.

Continuing the example, a manufacturer can properly attribute the portion of ROI enabled by a marketing event within a campaign. The manufacturer can then also properly attribute the portion of ROI enabled by the media types composing the respective media types. The portion of ROI enabled by the various venues composing the media types can also be attributed the respective venues. For instance, with a marketing campaign composed of three marketing events, each event might make use of three medias, such as web, print, and radio, with each medium itself utilizing three different venues (such as three different web sites, three different trade publications, three different radio ads) the ROI would be properly distributed for each of the venues, each of the media types, and each of the marketing events.

In one embodiment, the attributing of ROI of advertising and/or sales generation activities to sales events is enabled through the unique identification of a sales lead to a sales generation activity and the tracking of that sales lead as it is processed by sales agents. In another embodiment, the attributing of ROI of advertising and/or sales generation activities to sales activities is enabled through the probabilistic modeling of the sales lead creation with respect to sales generation activities. In another embodiment, the probabilistic modeling is also adaptive based upon the detailed information received over sales lead creation and fulfillment.

Another aspect of the present novel technology is the provision of a mechanism means to measure distributor performance and ensure distributor accountability. In B-to-D (and B-to-D^{N}) environments, it is difficult for businesses to evaluate the performance of their distributors with respect to sales leads. A business' difficulty in evaluating the performance of its distributors often stems from the inability for a business to track the actions that a distributor or distributor's agent may take in response to a sales lead. This novel technology provides for the measurement of distributor performance through the near real time tracking and recording of the actions taken by a distributor on a sales lead.

Still another aspect of the present novel technology is the provision of a knowledge repository containing information over a business' customers, sales generation activities, and sales support activities. The knowledge repository is ‘live’ in the sense that the knowledge spans historical to current information. The knowledge is also continuously updated through voice of customer feedback, activity information over the generation of sales leads, activity information over the handling of sales leads, and the like.

The present novel technology typically provides a mechanism for a business to specifically direct sales leads to specific actors, even where the actor is external to the business. As an example, consider the normal situation for a business operating in a B-to-D environment. Typically, the business has no control over which of its distributor's sales agents service the sales leads the business forwards to the distributor. Using the present novel technology, the business can direct which sales agents of its distributors receive the sales leads. The guidance of sales leads is typically accomplished through the provision of a unifying means of receiving sales leads and for providing sales activities feedback.

Similarly, the present novel technology also enables a business to construct work flow rules guiding the distribution of sales leads based upon various considerations. For example, a business might determine that sales leads of a certain type are better served by a specific distributor. Using the present novel technology, the business can construct work flow rules guiding the distribution of sales leads of a certain type to automatically be sent to a specific distributor.

Another aspect of the present novel technology is the enablement of a business to closely monitor and evaluate the actions of sales agents and/or distributors on the business' sales leads. Typically, a business has no viable or consistent means with which to monitor the actions taken by a third party, such as a distributor, on the business' sales leads. Using the present novel technology, a business is able to monitor the actions taken upon the business' sales leads. The business can also monitor the individual actions of the sales agents of a distributor take upon the business' sales leads. It is instructive to understand that collectively, the ability to measure distributor performance and to assign to distributors sales leads and track sales leads ensures distributor accountability. Further, the tracking and monitoring of sales agents are typically real time and displayed in interactive dashboards and detailed reports. Similarly, the tracking and monitoring of the performance of distributors are also typically real time and usually displayed in interactive dashboards and detailed reports.

Another aspect of the present novel technology is assistance of the sales agent in the performance of sales activities associated with a sales lead through providing a centralized knowledge repository. The sales agent can review the history associated with a sales lead and enter new information. The sales agent can also manage his schedule and activities and as well as schedule the activities of others with respect to a sales lead. For example, the sales agent can review the past sales to a customer associated with a sales lead, update the associated information, schedule follow up activities and arrange for the activities of other sales agents. The present novel technology will provide various informative reminders in response to the scheduled activities such as emails, calendar notices, ‘pop-ups’, electronically synthesized voice mails, and the like in response to the scheduled activities.

Another aspect of the present novel technology is the provision of a mechanism for management of business' distributors. The management of a business' distributors ranges from the level of management of collective entities, such as a distributor, all the way down to the individual entities of a collective entity, such as the sales agents of a distributor. The management of a business' distributors includes but is not limited to re-assignment of sales leads, creation of new sales lead distribution rules, implementation of new sales evaluation metrics, and the like.

Another aspect of the present novel technology is the provision of a mechanism for obtaining customer feedback. Often called voice of customer, customer feedback can be associated with any phase of the sales cycle, is associated with the creating sales generation activity, and is standardized. Standardization of the customer feedback enables meaningful comparisons of customer feedback originating from different sales lead generating activities to be made. Furthermore, similar to the tracking of sales leads, aspects or segments of the customer feedback can be attributed to the specific sales agents interacting with the sales lead.

Additionally, the information from a voice of customer is made actionable and typically immediately available. Voice of customer information is often captured, processed and distributed to those able to make use of the information. Example uses include forming and refining sales models and forecasts, triggering processes or automatic responses, enhancing or creating customer profiles, refining sales products or sales brochures, guiding the development and follow up of leads.

Another aspect of the present novel technology is the provision of timely and role based information. Because specific sales lead sales activities are tracked in near real time, near real time information can be provided over those tracked activities. However, not all entities involved the sales cycle require the same information. For example, an entity responsible for shipping an order doesn't need to know what sales generation activity eventually gave rise to the order. Likewise, a salesperson typically doesn't need to know the relative performance of his counter-part salespersons. The present novel technology restricts a user's access to the near real time sales activities information based upon the user's role.

The role restriction of information also works in situations where a salesperson does need to know the relative performance of his counter-part. For example, in a cross selling or collateral selling environment, a salesperson's role will limit the salesperson's access to information of his counter-part's performance to that of role-accessible information. The present novel technology also provides various tools for information sorting, collating, and the like tools with which to manipulate and process the near real time sales activities information. Furthermore, it is informative to note that the present novel technology does permit collaborative selling situations and the sharing of information in such situations.

Another aspect of the present novel technology is the incorporation of an industry's best practices into the sales workflow while permitting individual adaptation of the sales workflow processes for a specific company and the company's specific business model, sales processes, management processes, sales generation events, and the like. There are many benefits to a company from incorporating its corresponding industry's best practices into the company's processes. However, it is rare for a company, for one reason or another, to not have to vary from these best practices. For example, a company may be required to have special but less than ideal processes in response to a regulation imposed on the company but not imposed upon the industry as a whole. While incorporating a best practices model workflow, the present novel technology also permits rapid restricting of the sales workflows to accurately portray the sales workflows of the user company.

Furthermore, the ability to represent and customize a company's workflow yields another benefit. The enablement of a company to implement workflows designed to prevent “dropping” sales leads. A dropped sales lead is a lead that receives no or insufficient sales fulfillment activities. Work flows can be enhanced through the implementation of sales lead routing rules and special handling of sales leads in case of exceptions (unexpected events within the normal workflow processes). Workflows can even incorporate rules that guide specific types of sales leads to specific sales agents. Dropped sales leads are typically prevented through exception handling. For example, a sales lead that receives insufficient sales activities is noted as an exception. A work flow exception handling routine would then typically re-route the sales lead to another sales agent.

The following is a first, simplified description of a first embodiment of the present invention intended to clarify, without limitation, a system by which the work flow of the entire life-cycle of a business opportunity or lead is managed and evaluated for performance and fulfillment. The system enables global management of lead generation and the demand creation process, providing sales and marketing performance metrics, and engaging the lead prospect via a customer or consumer feedback request mechanism or the like.

The system is typically a role based system, insofar as an actor's access and capabilities are determined by his role in the business hierarchy. The scope of the system includes business to business and business to customer lead management capabilities. The life cycle of a lead is broadly defined and includes both pre-opportunity (demand creation) processes and post fulfillment (whether success or failure) evaluation and processes. Relationship management of the actors within the various work flows is also performed, evaluated and quantified. This system is equally applicable to on line, mixed and standard lead/demand creation processes.

In one embodiment, the system is initially configured with a generic work flow generally corresponding to the industry best practice template for the purchasing, or system utilizing, user entity. Work products initially consist of a plurality of standard work products associated with the purchasing company's industry best practice template. For example, in a business-to-business situation with one distributor level before the customer (consumer), the work product template typically may include survey, lead, customer feedback, contact (a specialized entity), entity, campaign (including subtypes, such as marketing and finance), event (including subtypes, such as marketing and finance), summary, collection (collection of other products), region, report, and form. The system is then mapped to the purchasing company's actual work products, work flows, rules and decision/evaluation processes. Work products are inherently generic in nature and may consist of other work products, each with its own work flow and decision/evaluation processes. Similarly, work flows may branch into other work flows, each with their own decision/evaluation processes and rules.

Attributes of work-products are typically customized to the purchasing company. A work product's attributes need not be fixed and can be role, rule (or work flow), or even process determined. Attribute types may typically include quantitative, qualitative, other work products, or decision/evaluation values. Work product and work flow details are also able to be exported and/or imported permitting the system to interact with other systems (such as Customer Relations Management software).

Decision/evaluation points within a work flow are likewise typically customized to the purchasing company. Decision/evaluation algorithms and rules are typically also customized to the purchasing company. Such algorithms need not be static or quantitative in nature. For example, a decision algorithm may be probabilistic in its application while returning the evaluation of a fuzzy set.

The following is a first, simplified description of a first embodiment of the present invention and is intended to clarify, without limitation, a customizable system for the automatic management and evaluation of business lead creation and development.

For companies selling goods and services in a one-step or a multi-step distribution channel, all sales are typically transacted via a distributor. In these situations, a ‘buyer’ cannot purchase directly from the manufacturer, but must instead purchase through a distributor. This presents a challenge for the manufacturer to measure the effectiveness of both the sales-generating activities and sales actions of individuals. Additionally, it is exceptionally difficult in such an environment to measure the influence of the marketing and advertising dollars spent to generate selling inquiries and to promote awareness of the brand. Even further, the number of actors, multiple layers insulating the manufacture from the ultimate purchaser, and the like, makes measuring ROI (Return on Investment) or other metrics for sales generation activities difficult, if not virtually impossible.

Typically, when the sales force of such a company is presented with a lead, the sales force will forward the lead, along with various auxiliary information, to a distributor sales representative. Often, the distributor sales representative is specifically chosen for his perceived past performance. However, there traditionally has been no automated and measured process for analyzing and quantifying the actual performance of that distributor sales representative. There also has been no means of recalling a lead from a non-performing or poorly performing distributor sales representative. Additionally, the separation between the manufacturer and the ultimate client prevents the manufacturer from receiving direct feedback from the ultimate client.

The multi-layer aspect of the distribution channel also presents informational problems for management, often resulting in a near vacuum of any reliable or meaningful information. The complexity of the information (multi-layered, within the organization, external to the organization, etc.) impairs meaningful analysis. Even where there is some analysis, the underlying data often can't be packaged to permit more in-depth analysis.

According to one embodiment of the present invention, a user creates the work product representing the marketing scheme being employed. The marketing scheme utilizes a subset of work products denoting a form for a perspective buyer to use to express interest in the product. Forms are customizable for any number of specific needs or goals. For example, forms can be customized for a client (or class of clients), a campaign, or for a specific marketing event. A customer's method and location of access identifies which specific form he is to use (example, on line campaigns can utilize specific links permitting form selection based upon URL).

A completed form's information is then acquired by the system (automatic for online, manually entered into the system for paper forms, and the like). The work flow process then begins and the information is used to populate a lead or sales opportunity. As previously stated, workflows are customized to the client's business rules and allow for ultimate flexibility in the routing, prioritization, and contact matching at the client, campaign, and marketing event level. The lead is then typically automatically evaluated, ranked, prioritized, and forwarded to a sales representative. The rules for the automatic evaluation, ranking, prioritizing, and forwarding of sales leads are typically a hybrid of company derived rules and best practices. It is instructive to note that the rules can easily be modified and can even be adaptive. Other possible actions include automatic fulfillment, sample sending, or anything else required by the business rules of the client. It should be noted that business rules may utilize any available information including past history, regional, data from form, and the like. More complex responses are also possible and may include splitting of the lead (dividing the opportunity among different sales representatives), multiple assignments of the lead, and the like.

Upon assignment, the custom workflow determines what steps are available at each point in the process. Typically, a sales person would view the lead first. Each action upon the lead adds to that lead's description and possibly alters the lead's status. For example, after the initial viewing, a lead moves from the status “new” to “in progress.” Actions available and states are also part of the customization to the client's work flow.

The assignment of a lead also prompts the system to notify the assignee (typically a sales person). Various forms of notification are possible and include email, voice mail, text message, and the like. The assignee then logs into the system and receives a concise view of his immediately actionable products (leads) from a summary screen. The content of the summary screen is determined by the role of the person logging in. For example, the summary screen of a sales representative is different from that of a regional manager.

One primary function of the summary screen is to compress and prioritize the often complex and varied information, permitting the fastest response on the most promising opportunities (leads). The summary screen also includes functionality to view all assignments, use filtering, sorting, and quick Search (full-text searching) functionality to find and organize their new, active, and completed lead assignments. Additional functionality includes the ability to maintain contacts and contact groups. Contacts are used later in the process for sales performance management purposes.

In a business-to-business sales structure, the sales representative typically would forward a lead to a distributor sales rep from their contact list. Where a sales representative has worked the lead, and a sales decision has been made, the sales representative or the distributor sales representative would typically complete a disposition or outcome form providing information to the system indicating whether a sale was made, what products/amounts were purchased (if a sale was made), or why a sale wasn't made (i.e., the lead was not a decision maker, the lead purchased a competitive product, or the like). This capturing of the disposition data is used to provide sales performance information across the sales structure, indexed by the individual sales representative. This permits a sales representative to see who is working the lead, any prior contacts and sales results from the lead respondent, and the like. Additionally, this collectively provides the sales representative with insight into past purchasing patterns and any past or ongoing sales efforts associated with the lead prospect. In other words, the system allows emergent purchasing patterns to be recognized and acted upon.

There are many other possible roles available within the system, with each role potentially having a role specific view of the system and data. For example, the sales manager's view is that of the Sales Performance Management dashboard. This dashboard includes Sales Force and Distributor Sales Force Performance measurements including total number of leads, new leads, in progress leads, completed leads, and average times to open, work, and close a lead, percentage of leads completed, percentage of leads resulting in a sale, and actual revenue associated with those sales. This view is summarized by sales representative in a hierarchical sales structure, allowing for n-layers of sales management to be viewed. There is also a drill down capability, permitting an upper management sales manager to review the view and information presented to subordinate sales managers and staff.

Separate graphical representations illustrate sales performance by distributor company showing similar metrics (total number of leads, in progress leads, and completed leads, average times to open, work, and close a lead opportunity, percentage of leads completed, percentage of leads resulting in sales, and actual revenue associated with those sales). The sales manager can similarly drill down into each distributor company to view the performance of the individual sales reps at each distributor company. This provides the sales manager with a complete, 360 degree view of the sales force, thus permitting evaluation of both internal and external sales staff. The availability of this information in a holistic dashboard view permits the sales management to have immediate visibility into issues with the performance of sales representatives and distributor sales representatives. This in turn permits fast and accurate actions to be taken to resolve problem issues. Examples of problem issues include but are not limited to imminent purchase decisions, product failure, over or under invoicing, improper shipping address, poor customer service, and the like.

Another typical role within the system is the marketing performance manager. The marketing performance manager's dashboard view yields concise information over marketing campaigns and events. Upper level marketing performance management has a drill down capability similar to that of upper sales management. The presented information also contains marketing event performance data. With this information, in addition to the costs associated with the marketing event, the system can calculate various metrics including ROI for each campaign and marketing event. The marketing performance manager would also have access to views illustrating the performance of each individual marketing event.

Drill down capability permits inspection of the performance of the individual channels used within a campaign. This allows the marketing manager to have a view of how each type of media (and each channel within that media type) is performing, both in terms of the number of leads generated and the actual revenue, ROI, and various other metrics.

There are also various other possible roles available, such as the hybrid sales and marketing performance management. This role's dashboard view focuses upon metrics of leads, sales conversion rates and weighted prioritization of leads. This allows such managers to determine where prioritization needs to be adjusted in order to more effectively exploit the sales force for maximum returns.

Another typical dashboard view is the Product Performance view. Relevant to sales and marketing, this view illustrates revenue and units sold grouped by product in a given date range, ultimately providing a revenue per product metric.

As part of the disposition form completed by the sales rep or distributor sales rep, questions are typically asked regarding the products purchased. From this, the system can determine and output a revenue amount based on product. This information is often relevant to a sales and a marketing manager and can be included in both dashboard views. This gives the marketing (and sales) manager a real-time view of what products are generating interest, selling or not and the insight to quickly adjust to market place changes. This information could also be used as an early indicator of production needs (i.e. if a particular product is generating a lot of interest/sales, the company may want to get more manufactured). Still other dashboard views provide information such as the number of leads and revenue by the industry type of lead respondents.

In order to track the effectiveness of lead creation activities, the system tracks the satisfaction of the ultimate client. To do this, the system utilizes an automated Voice of Customer (VOC) mechanism. Satisfying most six sigma compliance requirements for “marketing” (by encouraging inquirer/purchaser feedback to assess the overall experience the inquirer received), the VOC mechanism is engaged when client-defined triggers occur. Examples of such triggers typically may include ‘size of purchase’, ‘age of opportunity’, invoicing, product management, product delivery, and the like. Note that the VOC mechanism is tied to its respective marketing campaigns, events and various sales and or management staff. In this way, the VOC mechanism permits a complete view of the performance of the lead management process.

The following tables represent various information about one implementation of a customizable system for the automatic management and evaluation of business lead creation and development. In addition to being in table form, the information is also in use-case format.

### Role Based Interaction Example

Examples are depicted through use-case format.

### Roles/Actors

| Role Name | Description |
|---|---|
| Distributor Sales Rep | External employees that may not have a |
| | login, but will be able to complete a |
| | disposition form |
| Lead Coordinator | Client employees that are responsible for |
| (Client Sales Rep) | managing new lead requests that are in |
| | their territory. |
| Supervisor | Client employees that are responsible for |
| (Client Sales Manager) | managing one or more Lead Coordinators. |
| | They need to be able to see the leads for |
| | those sales persons that report to them. |
| | They will also be notified when a lead is |
| | not handled in a defined amount of time. |
| Distributor Relationship | Client employee responsible for |
| Manager | maintaining the relationship with key |
| | distribution channel partners. |
| Marketing Director | Client employee responsible for |
| | coordinating campaigns, marketing events, |
| | distribution and prioritization rules with |
| | system staff. They will want a “top-level” |
| | view of leads with drill-down capability. |
| System owner Account | System employee responsible for |
| Manager | managing the relationship with and the |
| | requirements of the Client. They have |
| | access across clients and will need to be |
| | able to reset passwords, manage the |
| | fulfillment process, and modify data, as |
| | needed. |
| System Administrator | System technical and executive level users |
| (Admin) | responsible for maintaining the system. |
| Public User | Any non-authenticated user that can |
| | complete a form or view information on |
| | public website about system. |

Actor Interaction with Lead Examples

| | |
|---|---|
| Name | Accept Lead Assignment |
| Description | This process allows the user to indicate that they accept the |
| | lead assignment. By doing so, they agree to manage |
| | the lead. |
| Actor | Lead Coordinator |
| Precondition | User has logged in |
| | A lead has been received and assigned to the Lead |
| | Coordinator |
| Post | Lead is marked as accepted |
| condition | |

| User Action | System Action |
|---|---|
| The user clicks to view the | The lead details are displayed and the |
| details of the lead | lead assignment is marked as accepted. |

| | |
|---|---|
| Name | Reject Lead Assignment |
| Description | This process allows the user to indicate that they reject the |
| | lead assignment. |
| Actor | Lead Coordinator |
| Precondition | User has logged in |
| | A lead has been received and assigned to the Lead |
| | Coordinator |
| Post | |
| condition | |

| User Action | System Action |
|---|---|
| The user clicks to reject the lead | Prompts the user for a reason for |
| assignment | rejection |
| The user completes the requested | Flags the assignment as rejected and |
| information and clicks to submit | removes it from lead coordinator's |
| | assignments |

| | |
|---|---|
| Name | View Lead Assignments |
| Description | The user can view lead assignments for the Lead |
| | Coordinators that report to them. System will allow user to |
| | find/filter lead assignments based on a variety of criteria |
| | Accepted |
| | Rejected |
| | Overdue |
| | Assigned to distributor |
| | Date |
| | Region |
| | Temperature |
| | Completed |
| | VOC completed |
| | . . . and many more |
| Actor | Lead Coordinator, Supervisor, System Account Manager |
| Precondition | User has logged in and has appropriate permissions |
| Post | |
| condition | |

| User Action | System Action |
|---|---|
| The user clicks to view lead assignments | Displays Lead List screen |

| | |
|---|---|
| Name | Reject Lead |
| Description | The user can reject a lead. This would be equivalent to |
| | flagging a lead as a bad lead. |
| Actor | Lead Coordinator, Supervisor, System Account Manager |
| Precondition | User has logged in |
| | User has permissions to reject a lead |
| Post | All lead assignments for this lead have been cancelled |
| condition | |

| User Action | System Action |
|---|---|
| The user clicks to reject the lead | Display related lead assignments and |
| | prompt user to confirm lead rejection |
| The user clicks to confirm | Related lead assignments are cancelled |
| | and lead is flagged as invalid |

| | |
|---|---|
| Name | Transfer a lead assignment |
| Description | The user can transfer a lead assignment to another user. |
| Actor | Lead Coordinator, Supervisor, MILLERPIERCE Account |
| | Manager |
| Precondition | User has logged in |
| | The lead is currently assigned (i.e. not rejected). |
| | The lead was assigned to a lead coordinator that reports to |
| | the supervisor (if a supervisor user) |
| | The lead was assigned to the current user (if lead |
| | coordinator) |
| Post | Lead is reassigned |
| condition | |

| User Action | System Action |
|---|---|
| The user clicks to reassign a lead | Prompts the user for a reason for |
| | reassignment and who to reassign to |
| The user provides requested | Lead assignment is transferred |
| information | |

| | |
|---|---|
| Name | Assign a lead |
| Description | The user can assign a lead to a user. |
| Actor | Supervisor, System Account Manager |
| Precondition | User has logged in |
| | The lead was originally assigned to a lead coordinator that |
| | reports to the supervisor (if a supervisor user) |
| | The lead was previously rejected or unable to be assigned |
| | (i.e. not currently assigned) |
| Post | Lead is assigned |
| condition | |

| User Action | System Action |
|---|---|
| The user clicks to assign a lead | Prompts the user for who to assign to |
| The user provides requested | The lead is assigned to the selected |
| information | person and the event is added to the |
| | lead history. |

| | |
|---|---|
| Name | Cancel a lead assignment |
| Description | The user can cancel the assignment of a lead to a user. |
| Actor | Supervisor, System Account Manager |
| Precondition | User has logged in |
| | The lead was originally assigned to a lead coordinator that |
| | reports to the supervisor (if a supervisor user) |
| | The lead was assigned to the current user (if lead |
| | coordinator) |
| Post | Lead assignment is cancelled |
| condition | |

| User Action | System Action |
|---|---|
| The user clicks to cancel a lead | Prompts the user for a reason for |
| assignment | cancelling |
| The user provides requested information | Lead assignment is cancelled |

| | |
|---|---|
| Name | Create a distributor lead assignment |
| Description | The user can create a lead assignment to a Distributor |
| | Sales Rep |
| Actor | Lead Coordinator, Supervisor, System Account Manager |
| Precondition | User has logged in |
| | The lead is currently assigned (i.e. not rejected). |
| | The lead was assigned to a lead coordinator that reports to |
| | the supervisor (if a supervisor user) |
| | The lead was assigned to the current user (if lead |
| | coordinator) |
| Post | Lead is assigned to a Distributor Sales Rep |
| condition | |

| User Action | System Action |
|---|---|
| The user clicks to forward a lead | Prompts the user who to forward |
| | to displaying address book |
| | (see Manage Address Book UC) |
| The user selects a Distributor Sales Rep | Distributor Lead Assignment is |
| | created |

| | |
|---|---|
| Name | Reassign distributor lead assignment |
| Description | The user can reassign a distributor lead assignment to |
| | another distributor contact. |
| Actor | Lead Coordinator, Supervisor, System Account Manager |
| Precondition | User has logged in |
| | The lead is currently assigned (i.e. not rejected). |
| | The lead was assigned to a lead coordinator that reports to |
| | the supervisor (if a supervisor user) |
| | The lead was assigned to the current user (if lead |
| | coordinator) |
| | The lead was assigned to a Distributor Sales Rep |
| Post | Lead is reassigned to another Distributor Sales Rep |
| condition | |

| User Action | System Action |
|---|---|
| The user clicks to reassign | Prompts the user for a reason for |
| distributor lead assignment | reassignment and who to reassign to |
| | displaying address book (see Manage |
| | Address Book UC) |
| The user selects a Distributor | Distributor lead assignment is reassigned |
| Sales Rep | |

| | |
|---|---|
| Name | Cancel distributor lead assignment |
| Description | The user can cancel a distributor lead assignment. |
| Actor | Lead Coordinator, Supervisor, System Account Manager |
| Precondition | User has logged in |
| | The lead is currently assigned (i.e. not rejected). |
| | The lead was assigned to a lead coordinator that reports to |
| | the supervisor (if a supervisor user) |
| | The lead was assigned to the current user (if lead |
| | coordinator) |
| | The lead was assigned to a Distributor Sales Rep |
| Post | Distributor lead assignment is cancelled |
| condition | |

| User Action | System Action |
|---|---|
| The user clicks to cancel distributor lead | Prompts the user for a reason for |
| assignment | cancellation |
| The user provides requested information | Distributor lead assignment is |
| | cancelled |

| | |
|---|---|
| Name | Flag lead assignment for follow-up |
| Description | The user can flag a lead assignment for follow-up. |
| Actor | Lead Coordinator, Supervisor, System Account Manager |
| Precondition | User has logged in |
| | The lead is currently assigned (i.e. not rejected). |
| | The lead was assigned to a lead coordinator that reports to |
| | the supervisor (if a supervisor user) |
| | The lead was assigned to the current user (if lead |
| | coordinator) |
| Post | Lead assignment is flagged for follow-up |
| condition | |

| User Action | System Action |
|---|---|
| The user clicks to flag a lead | Prompts the user for a reason for |
| assignment for follow-up | follow-up and a date/time to |
| | follow-up |
| The user provides requested information | Lead assignment is flagged for |
| | follow-up |

| | |
|---|---|
| Name | Complete a Lead Assignment |
| Description | The user can complete a lead assignment. |
| Actor | Distributor Sales Rep, Lead Coordinator, Supervisor, |
| | System Account Manager |
| Precondition | If Distributor Sales Rep: |
| | User clicks on a link in an email to a disposition form |
| | If Client user: |
| | User has logged in |
| | The lead is currently assigned (i.e. not rejected). |
| | The lead was assigned to a lead coordinator that reports to |
| | the supervisor (if a supervisor user) |
| | The lead was assigned to the current user (if lead |
| | coordinator) |
| Post | Lead assignment is completed |
| condition | |

| User Action | System Action |
|---|---|
| The user clicks to complete a lead | Displays a Disposition form |
| assignment | |
| The user enters requested information | Lead assignment is completed |

| | |
|---|---|
| Name | Complete a VOC (Voice of Customer) |
| Description | The user can complete a VOC form |
| Actor | Public User |
| Precondition | The public user initially completed a Lead Request form |
| | An email containing a link to a VOC form has been sent to |
| | the user |
| Post | Lead is completed or assigned (handled by workflow) |
| condition | |

| User Action | System Action |
|---|---|
| The user clicks to complete a | Displays a VOC form |
| VOC | |
| The user enters requested | Lead is completed if no further action is |
| information | required or Lead is assigned to a Lead |
| | Coordinator if answers to questions |
| | indicate further action is required. |

| | |
|---|---|
| Name | Manage Address Book |
| Description | The user can maintain an address book for the purposes of |
| | forwarding leads to distributor sales reps or storing general contacts. |
| | Whenever possible, the system will force the reuse of existing |
| | contacts rather than creating new contact records. |
| Actor | Lead Coordinator, Supervisor, System Account Manager |
| Precondition | The user has logged in. |
| Post | User's address book is updated by updating, adding, or disabling |
| condition | contacts |

| User Action | System Action |
|---|---|
| The user clicks to manage address book or | Display address book filtered/ordered |
| clicks to forward a lead to a distributor | by Distributor, Region, and Distributor |
| sales rep | Contact |
| Update: | |
| The user updates existing contact | Updated information is saved to |
| information | Address Book |
| Create Distributor Sales Rep Contact: | |
| The user clicks to add a new distributor | Displays a list of Distributor Companies |
| contact | Displays a list of Distributor Regions |
| The user selects a distributor company | Displays a list of Distributor Contacts |
| The user selects a distributor region | Information is saved to Address Book |
| The user selects an existing contact | New Contact form is displayed |
| The user creates a new contact | Contact record is created and |
| The user completes New Contact form | information is saved to User's Address |
| | Book |
| Create Standard Contact: | |
| The user clicks to add a new standard | New Contact form is displayed |
| contact | Contact record is created if not matched |
| The user completes New Contact form | to existing and information is saved to |
| | User's Address Book |
| Disable Contact: | |
| The user clicks to disable a contact | Displays any incomplete distributor lead |
| | assignments sent to the selected contact |
| | and prompts to Cancel or Reassign |
| | Distributor Lead Assignment (if any |
| | exist) |
| User confirms disabling | Prompts for confirmation and reason |
| | for disabling (reason optional) |
| | Address Book record is disabled |

| | |
|---|---|
| Name | Create a Fulfillment Assignment |
| Description | The user can create a fulfillment assignment. Fulfillment is |
| | used to refer to any samples or literature sent to a lead |
| | prospect. Fulfillment assignments can also be created by the |
| | system based on answers on a Lead Request Form. |
| Actor | Lead Coordinator, Supervisor, System Account Manager |
| Precondition | User has logged in |
| | The lead is currently assigned (i.e. not rejected). |
| | The lead was assigned to a lead coordinator that reports to |
| | the supervisor (if a supervisor user) |
| | The lead was assigned to the current user (if lead |
| | coordinator) |
| Post | Fulfillment assignment is created |
| condition | |

| User Action | System Action |
|---|---|
| The user clicks to send a | Displays Fulfillment Request form |
| sample/literature item | |
| The user enters requested information | Fulfillment assignment is created |

| | |
|---|---|
| Name | Complete a Fulfillment Assignment |
| Description | The user can complete a fulfillment assignment by |
| | sending required samples and/or literature. |
| Actor | System Account Manager |
| Precondition | User has logged in |
| Post | Fulfillment assignment is completed |
| condition | |

| User Action | System Action |
|---|---|
| The user clicks to view open Fulfillment | Displays open Fulfillment |
| assignments | Requests |
| The user selects all or selects individual | Fulfillment manifest is |
| fulfillment assignments then clicks | generated in Excel |
| download | |
| The user can alternately select Deny on | Prompts for confirmation |
| selected fulfillment assignments | then completes fulfillment |
| | assignment with a status of |
| | denied |
| The user uses the downloaded Excel doc | Processes the updated Excel |
| to create a mail merge for letters/mailing | doc and completes the |
| labels, indicates in a status field whether | fulfillment assignment |
| fulfillment was shipped or denied, | |
| includes a date/time, and uploads the | |
| excel doc | |

### System Information Display to Actors Examples

| Screen Name | Description |
|---|---|
| 1. Lead Detail | Shows the details of a lead assignment, |
| | including contact info, answers to |
| | questions on lead request form, notes, and |
| | any lead history (from this and any other |
| | contacts from the individual). |
| 2. Lead List | Shows the leads that have been assigned to |
| | the logged in user, the leads assigned to |
| | the sales staff that reports to the logged in |
| | user (if supervisor), all leads for a client (if |
| | Marketing Admin), or all leads for all |
| | clients (if System Account Manager). |
| 3. Reports | Shows a list of pre-defined reports that the |
| | user has access to run. |
| 4. Fulfillment | Displays a list of all open fulfillment |
| | assignments, allows the user to select |
| | which to export, and then allows the user |
| | to import an updated Excel doc with |
| | changes. This screen will only be used by |
| | MILLERPIERCE Account Managers. |
| 5. Admin | Allows for user, campaign, and marketing |
| | event management. This screen will |
| | eventually be extended to include Client, |
| | routing and prioritization workflow |
| | management, and email template |
| | management. |

### Forms Examples

| Form Name | Description |
|---|---|
| 1. Lead Request Form | A form containing a survey (and |
| | potentially other information) presented to |
| | a prospect upon responding to a marketing |
| | event or visiting the “Contact Us” page of a |
| | client's website |
| 2. Disposition Form | A form completed by a sales person or a |
| | distributor sales person that indicates the |
| | outcome of a lead including purchase |
| | plans. |
| 3. VOC | A form that allows the customer to indicate |
| (Voice of Customer) | their level of satisfaction with the sales |
| Form | process, purchase plans, and/or request |
| | for additional information. Generally, a |
| | request for this information is sent via |
| | email to a lead prospect after a Disposition |
| | form has been completed or after a given |
| | time period from completion of the Lead |
| | Request Form. |
| 4. Fulfillment | A form accessed from the lead details or |
| Request Form | lead list screen that allows the user to |
| | request fulfillment items to be sent to a |
| | lead prospect. |

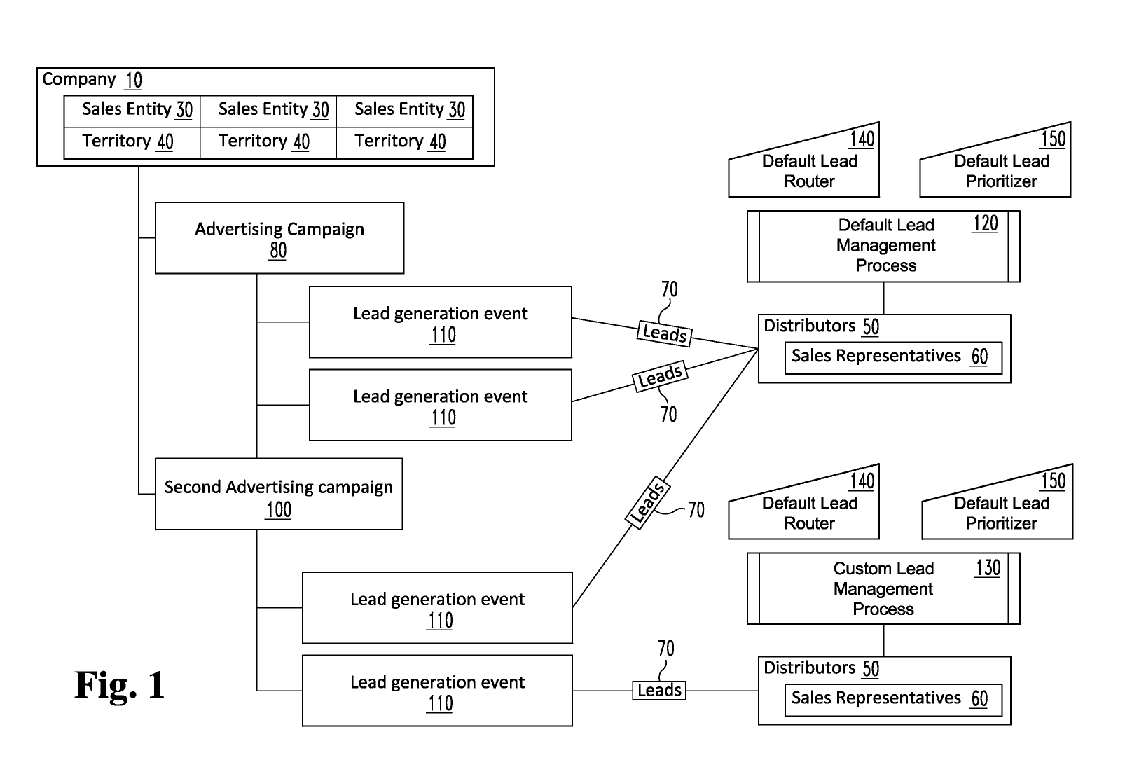

FIG. 1 is an example process diagram of lead management for an example company 10. In this example, the company 10 is a U.S. domestic only Widgets manufacturer that sells through a distribution channel 20. Company 10 has sales entities 30 of three people, each covering a territory 40 consisting of a range of states. Sales entities 30 work with a small number of distributor entities 50, each with a small number of distributor sales representatives 60.

Company 10 typically manages its sales leads 70 in the same manner for all advertising campaigns 80 and sales lead generating events 90. Advertising campaign 80 includes a second advertising campaign 100. For example, the second advertising campaign 100 could be the presentation of a specific new product at a trade show. Company 10 wishes to treat sales leads 70 generated from the second advertising campaign 100 differently from the sales leads 70 generated by the first advertising campaign 80.

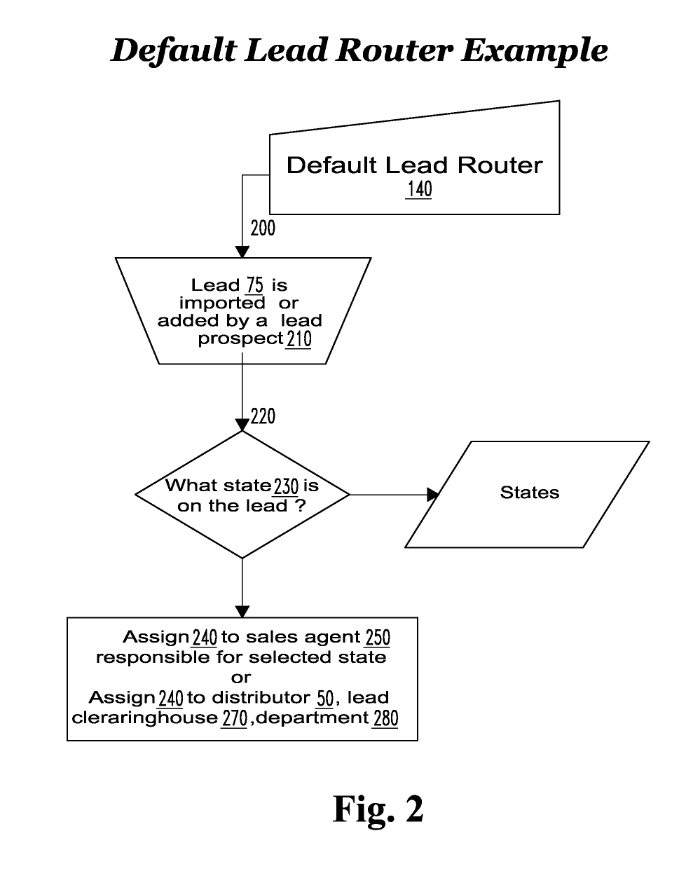

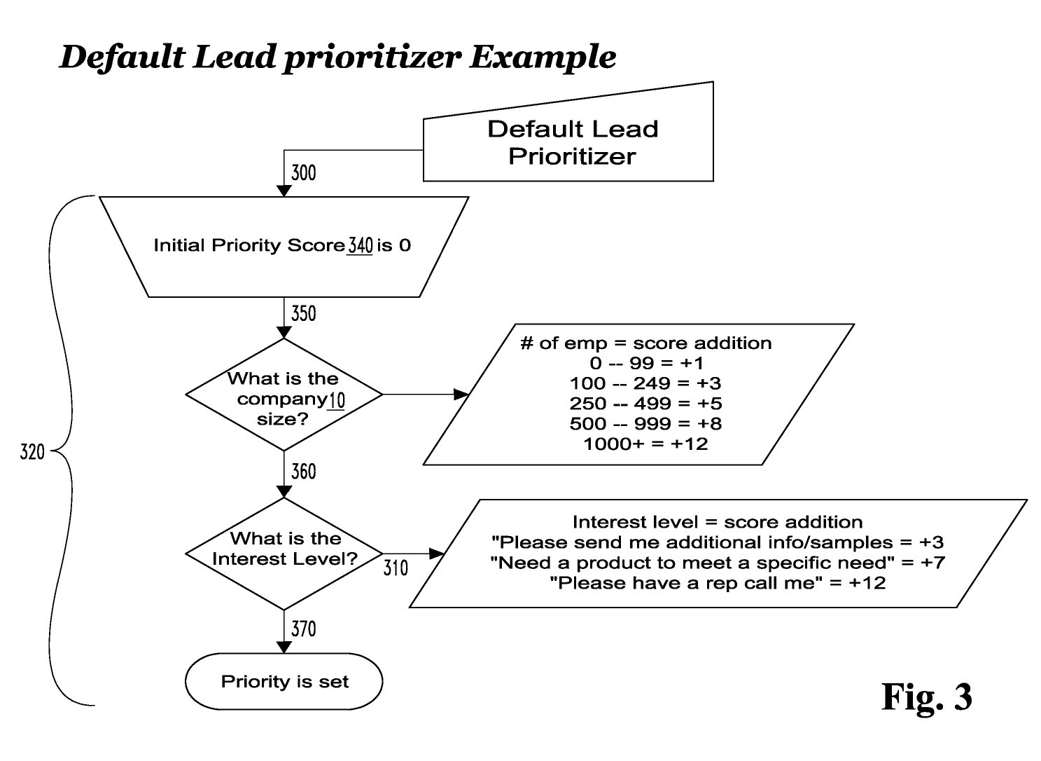

Both the advertising campaign 80 and second advertising campaign 100 are each composed of two sales lead generating events 110 (for a total of four sales lead generating events 110). The processing or handling of sales leads 70 is performed by a default sales lead processing 120 or custom sales lead processing 130. FIG. 1 also depicts the existence of sales lead routing 140 and sales lead prioritization 150. Typical implementation of sales lead routing 140 and sales lead prioritization 150 is further depicted in FIG. 2 and FIG. 3, respectively.

FIG. 2 is an example of typical sales lead routing 140 depicted in flow chart form. In this figure and in step 200, a sales lead 70 is acknowledged and added to the system. Typically, the acknowledgement and adding of sales lead 70 to the system is performed either electronically or though the actions of a sales lead prospect 210.

A sales lead 70 is typically characterized as occupying one or more states 230. Examples of states' 230 include high value, high priority, special, high/low value client, east coast region, west coast region, and the like. While most simply thought of as representing a condition or attribute of the sales lead 70, the state 230 typically represents a highly configurable and customizable collection of information. The information contained within a state 230 will usually vary from installation to installation of the system 5. Further, the information contained within a state 230 may even vary from one sales lead generating event 90 to another sales lead generating event 90. State 230 of the sales lead 70 is then evaluated 220.

Sales lead 70 is assigned 240 based upon state 230. While the sales lead 70 is depicted within FIG. 2 as being assigned 240 to a sales agent 250, there exist other possible assignments. Examples of other possible assignments include assigning sales lead 70 to a distributor 50, to sales lead clearing house 270, to a sales department 280, and the like.

FIG. 3 is an example of typical sales lead prioritization depicted in flow chart form. While the example that FIG. 3 depicts is that of a prioritizing scheme 320 based upon the size of the company 10 corresponding to the sales lead 70 and the company's 10 interest level 310, it should be noted that there are many other possible prioritization schemes 320.

A sales lead 70 is given an initial prioritization score 340 in process step 300. The initial prioritization score 340 of sales lead 70 is increased based upon the size of the corresponding company in process step 350. The prioritization score 340 of sales lead 70 is further refined in process step 360 based upon the interest level of the company 10. A final prioritization score 340 is fixed for the sales lead 70 in process step 370.

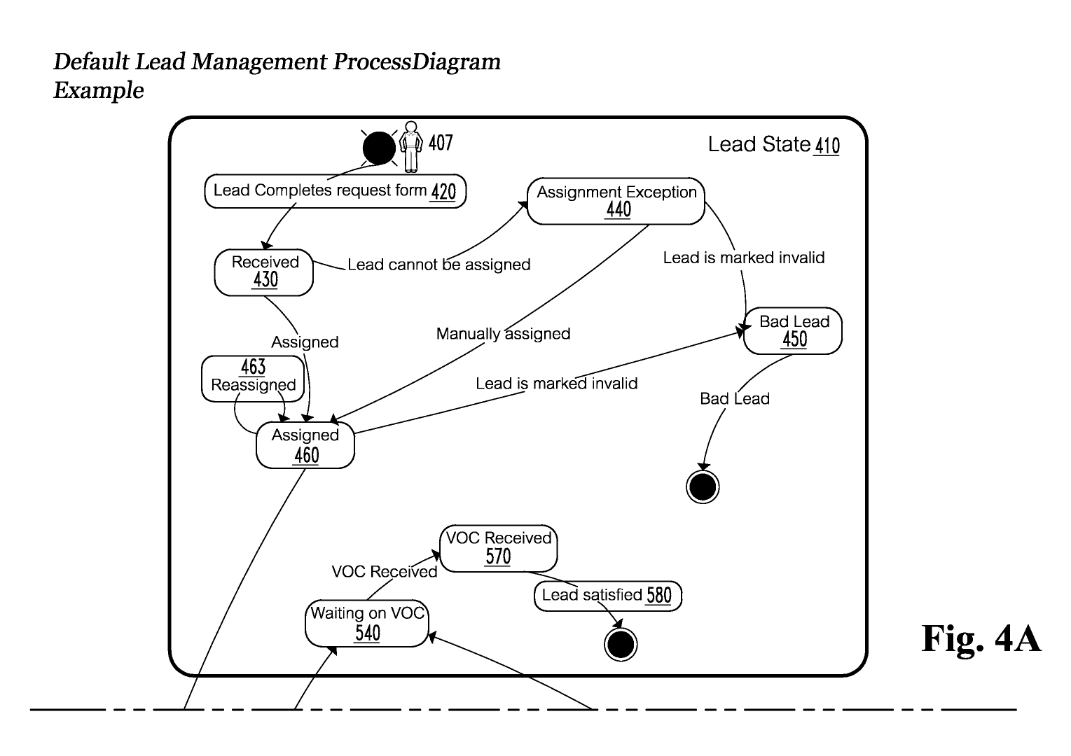

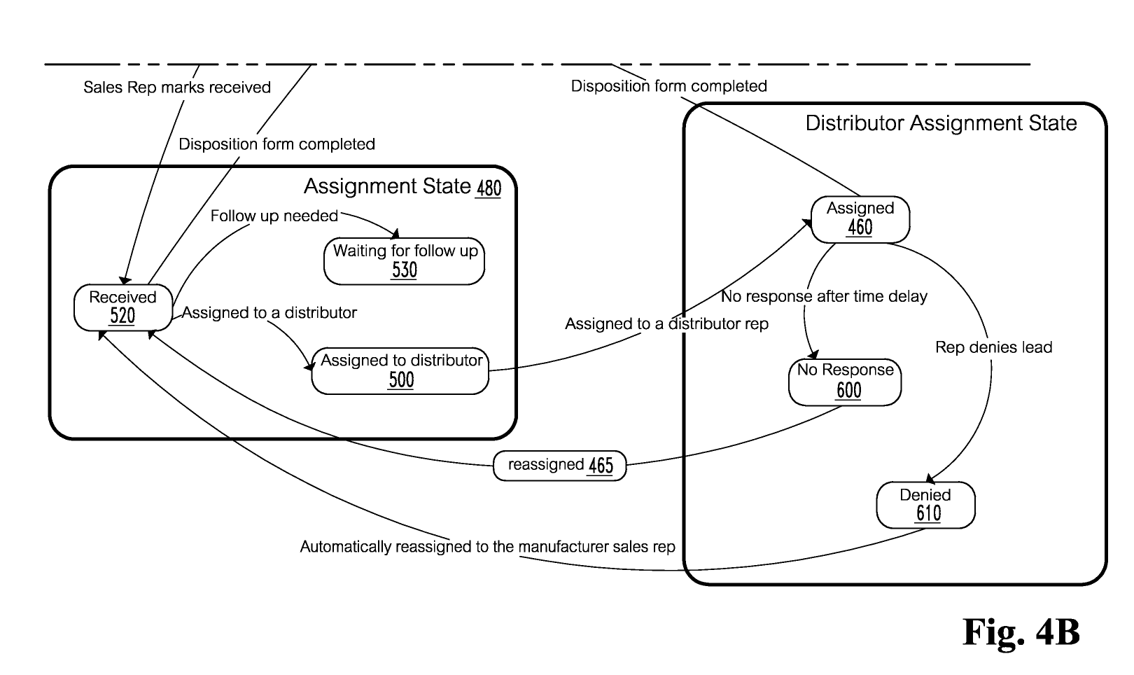

FIG. 4 is a diagram of an example sales lead management process 400 for one implementation of the applicant's novel technology as depicted in FIG. 1 for the default lead management process. FIG. 4 depicts the most common actions within the three major states of a sales lead 70. FIG. 4 begins with Sales Lead State 410 where an actor 407 makes his interest in a product or service known through completing a lead request form 420. Likewise an actor 407 could make his interest known through other means, such as personal contact with a sales representative, a phone call to a sales representative, an email to a sales representative, and the like.

The sales lead 70 enters into a received and reviewed state 430. A determination is typically made at this time as to whether or not the sales lead 70 can be assigned 240. If the sales lead 70 can be assigned 240, it is assigned 240 and the sales lead 70 enters into an assigned state 460. If the sales lead 70 cannot be assigned 240, then there is an assignment exception 440. A sales lead assignment exception 440 typically experiences one of two viable exits. The sales lead 70 is either manually assigned 240 or the sales lead 70 is entered into a bad sales lead 450 state. Sales leads 70 that enter into a bad sales lead 450 state receive no further processing.

A sales lead 70 in the assigned state 460 can be reassigned 463, left in the assigned state 460, or it can be noted as a bad sales lead and enter into the bad sales lead state 450. It is informative to note that reassignment 460 is a generic term with a broad enough definition to include non-sales entities. For example, a sales lead 70 could be reassigned 463 for reevaluation 465.

A sales lead 70 stays in the assigned state 460 until a sales entity (most often a sales representative or sales agent 250) receives the assigned sales lead 70. It is informative to note that the act of receiving a sales lead 70 places the sales lead 70 into the state of being received 520 while imposing requirements upon the receiving actor 407. For example, a sales agent 250 receiving a sales lead 70 incurs various requirements associated with the sales lead 70. Changing the state of a sales lead 70 from assigned to received 520 also changes the major state of the sales lead 70 from that of sales lead state 410 to assigned state 480. A sales lead 70 can transition received 52o to waiting for follow up 530 or to assigned to a distributor 500.

A received 520 sales lead 70 can also enter into a state of waiting on voc 540. The normal transition is for a sales lead 70 to exit from waiting on voc 540 and enter into received voc state 570. Other possible states, though not shown, include entering into a no response state, typically after a waiting period, no voc possible, no voc needed, and the like. Normally, a sales lead 70 transitions to being satisfied 580 after receiving a voc feedback.

Once assigned to a distributor, a sales lead 70 can transition to the major state of being in a distributor assigned state 560 through the distributor assigning 590 the sales lead 70. The typical scenario for this is where a distributor 500 assigns the sales lead 70 to a distributor representative (a sales agent 250). A distributor assigned 590 sales lead 70 can also enter into a state of waiting on voc 540.

Other typical states include entering into a no response 600 state after a period of delay or a state of denied 610 by the sales representative. Usually, a no response state 600 and a denied state 610 cause the sales lead 70 to revert back to a received state 520 with the owner being a manufacturer's sales agent 250.

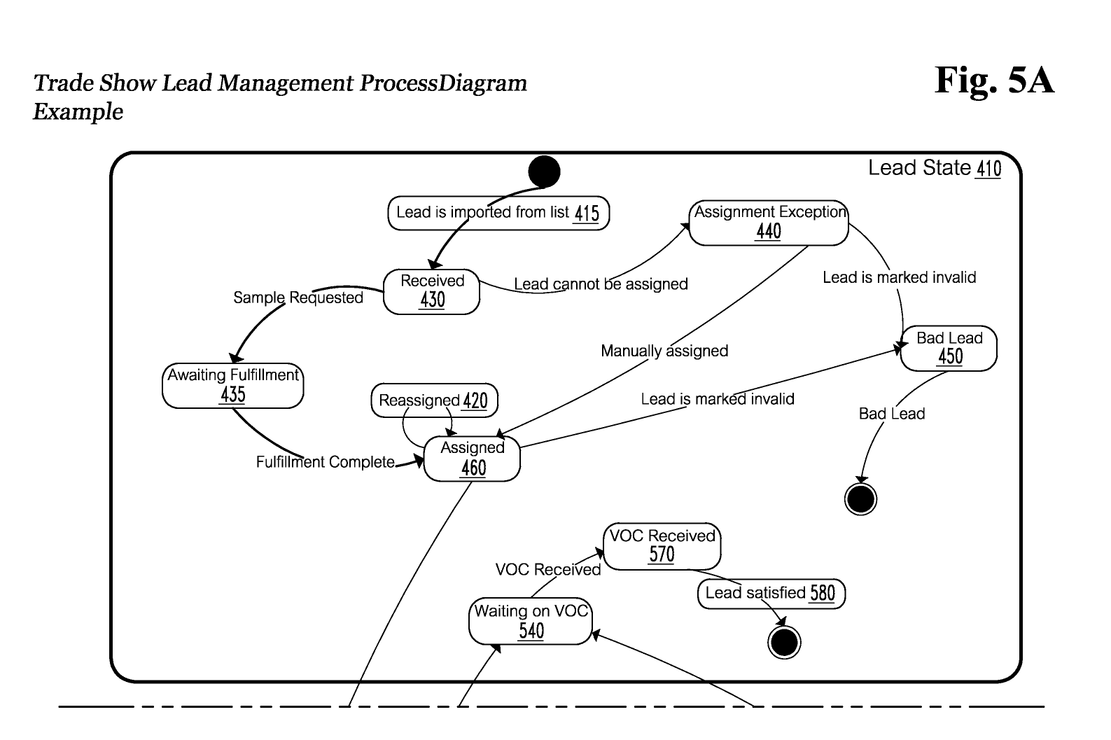

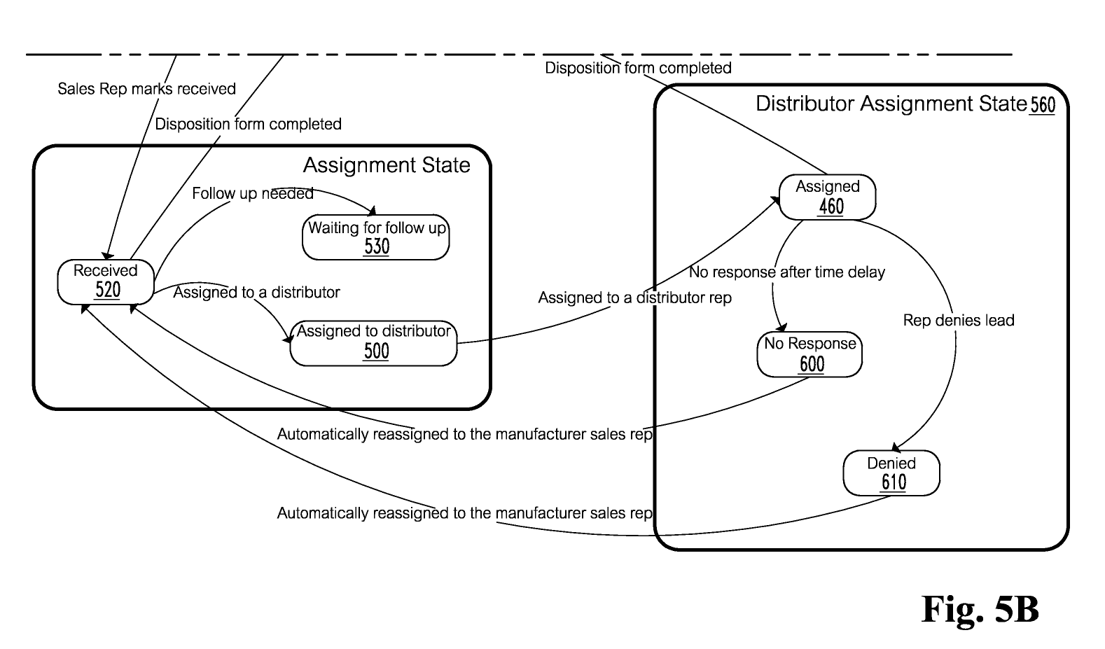

FIG. 5 is a diagram of an example of a custom lead management process 130 (in this example, representing a custom trade show lead management process) for one implementation of the applicant's novel technology as depicted in FIG. 1 for the specialized trade show sales lead 70 management process. Similar to FIG. 4, a sales lead 70 can exist within one of three major states; starting sales lead state 410, assigned state 480, and distributor assigned state 560. Unlike in FIG. 4, a trade show sales lead 70 custom lead management process 130 typically will utilize an automated or high volume method of accepting notices for entering into sales transactions (sales leads 70). The high volume method of accepting notices for entering into sales transactions is generically represented in FIG. 5 as lead importation 415. Once imported, a trade show sales lead 70 enters into a state waiting fulfillment 435. In practice, waiting fulfillment 435 typically denotes an additional review and handling concerns not presenting within the normal lead management process. For example, waiting fulfillment 435 often will include additional review by a fulfillment officer where he might impose additional constraints upon the future handling of the sales lead 70. Other than sales lead importation 415 and waiting fulfillment 435, the handling of a sales lead 70 is much the same for the typical trade show sales lead management process as the handling of a sales lead 70 is for the default sales lead management process.

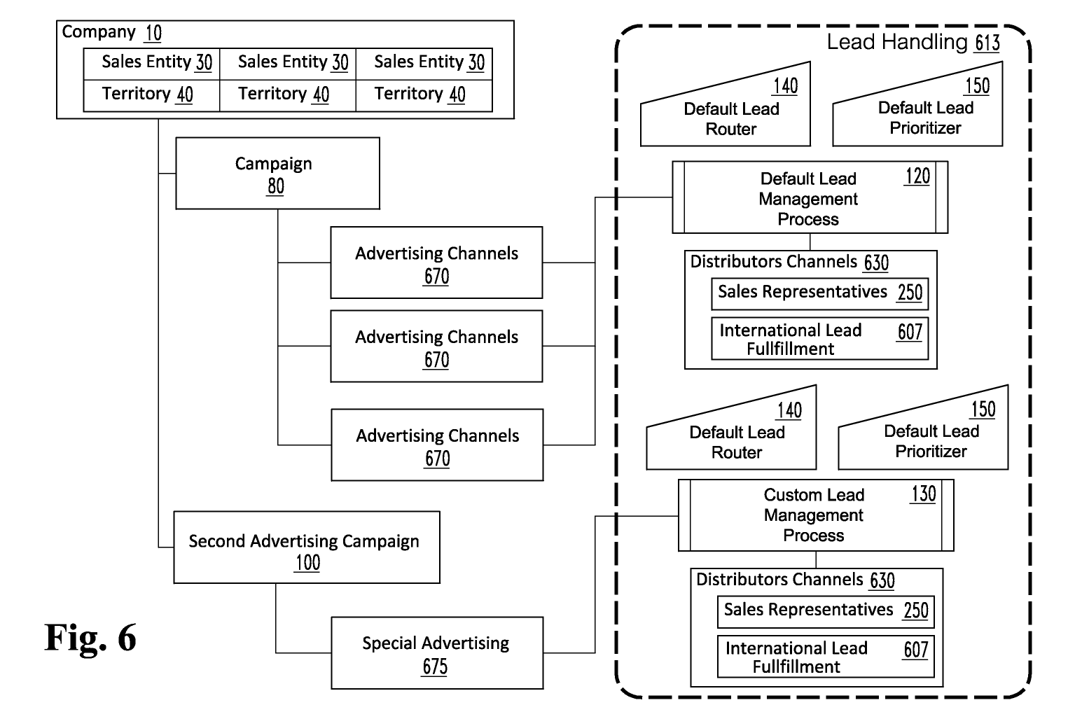

FIG. 6 is an example process diagram of sales lead management 605 for an example international company 10 utilizing a distribution channel 630 for both national and international sales lead fulfillment 607. In this example, company 10 also has a sales force 613 of several sales agents 250 with the responsibilities for national and international sales divided among the sales agents 250. In this example, company 10 has its typical advertising campaign 80 expressed through three main advertising channels 670. Advertising channels 670 can also be thought of as commonly used and reoccurring sales generation activities no collectively linked to an advertising campaign 80. Example advertising channels 670 could include a web site, advertising in a industry periodical, a targeted email campaign based upon an industry periodical's subscribership, and the like.

Company 10 also has a second and specialized advertising campaign 100 making use of a specialized advertising channel 675. In this example, company 10 wants to separately track the sales leads 70 created by the second and specialized advertising campaign 100. Company also wants the sales leads 70 created by second and specialized advertising campaign 100 to be specifically routed to a specialized quality managing sales agent 250.

Similar to FIG. 1, FIG. 6 also has a default sales lead management process 120 and a specialized sales lead management process 130. Default sales lead management process 120 handles the sales leads 70 created by the standard advertising campaign 80. Specialized sales lead management process 130 handles the sales leads 70 created by specialized advertising campaign 100. Also similar to FIG. 1 are the sales lead router 140 and sales lead prioritizer 150. The basic idea in this example is that the sales lead handling 613 has been customized to enable different handling and processing of sales leads 70 based upon which advertising campaign is responsible for the sales lead 70.

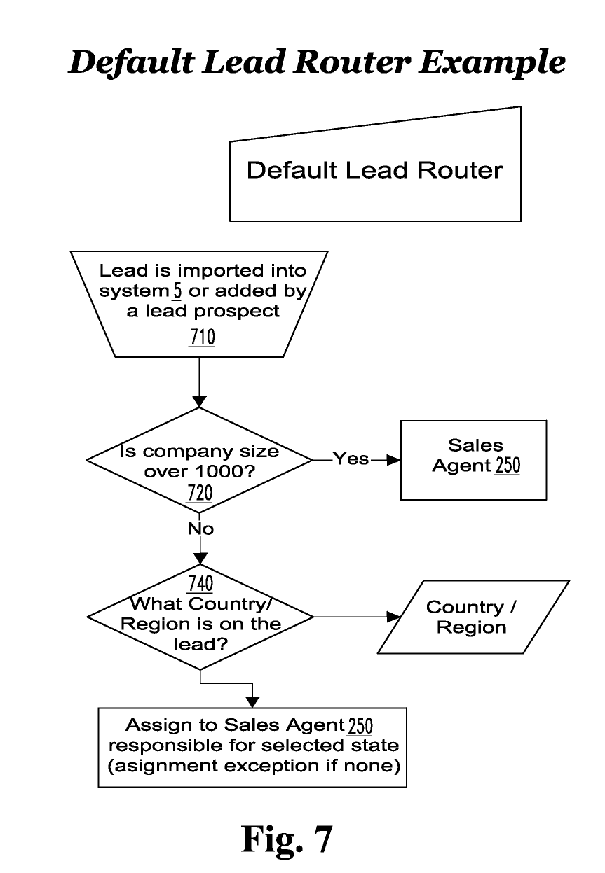

FIG. 7 is an example of a typical sales lead routing 700 for the example sales lead handling 613 shown in FIG. 6. In this figure and in step 710, sales lead 70 is imported to the system 5. In step 720, the router routes sales leads 70 that correspond to clients in excess of certain amount of employees to a specific sales agent 250. For example, the router could route all sales leads 70 from clients of excess of a thousand employees to a sales manager.

In step 740, sales leads 70 not previously assigned in step 720 are assigned to a sales agent 250 based upon some distinguishing characteristic. For example, step 720 could assign sale leads 70 to sales agents 250 based upon the country of the company associated with the sale lead 70.

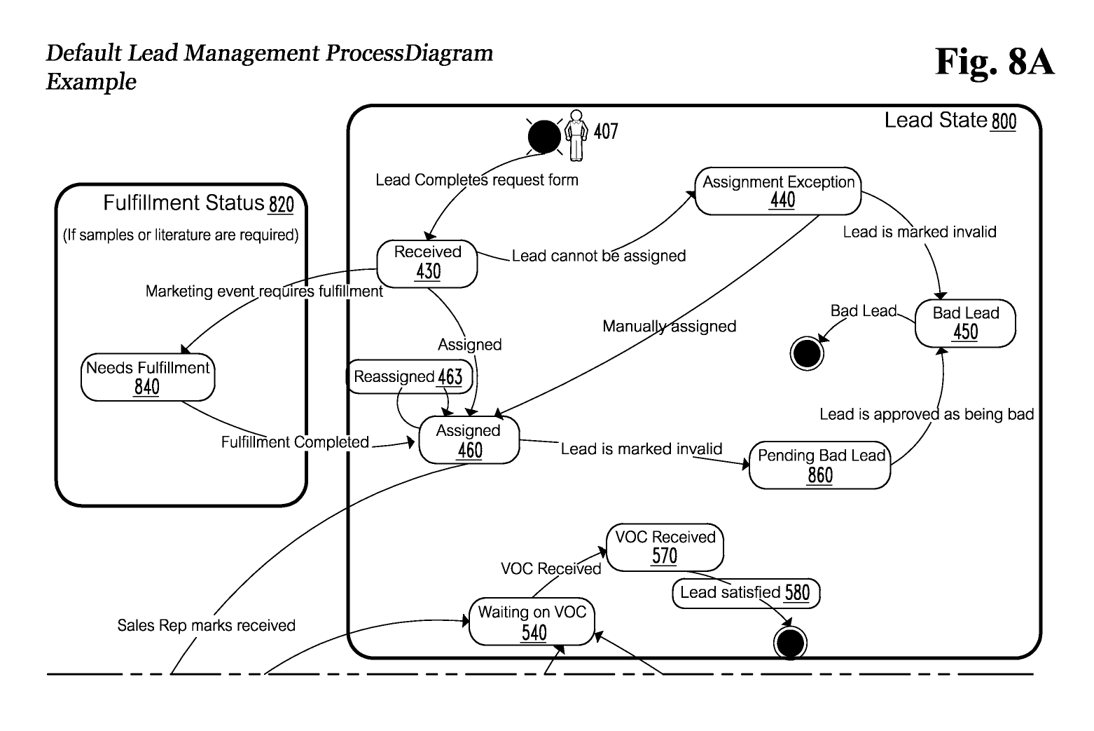

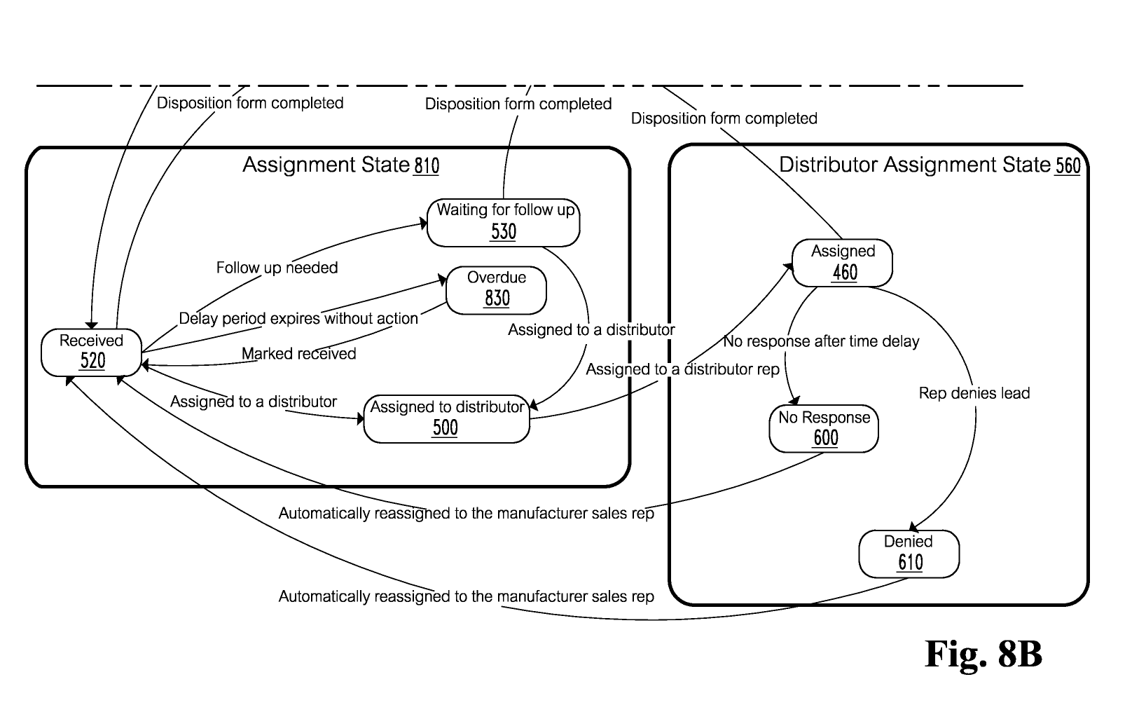

FIG. 8 is an example of a possible implementation of a default sales lead process diagram for the example manufacturing and product distribution depicted in FIG. 6. The diagram depicts the most common actions within the four major states of a sales lead 70 with respect to the situation described in FIG. 6. The diagram starts in sales lead state 800 with an actor 407 making his possible willingness to engage in a sales transaction known through completing a sales lead request form 420. It should be noted that there are a multitude of other means by which an actor 407 could make his willingness to engage in a sales transaction known. Examples include through personal contact of the actor with a sales representative, with a phone call to a sales representative, with an email to a sales representative, and the like.

Sales lead 70 then enters into a received and reviewed state 430. A determination is made at this time as to whether or not sales lead 70 can be assigned 460 or if additional materials are needed for the assignment 460 of the sales lead 70. If the sales lead 70 can be assigned 460, it is assigned 460 and the sales lead 70 enters into an assigned state 460. If sales lead 70 cannot be assigned 460, then there is an assignment exception 440. A sales lead assignment exception 440 generally experiences one of two viable exits. The sales lead 70 can either be manually assigned 460 or sales lead 70 can enter into a bad sales lead state 450. Sales leads 70 that enter into a bad sales lead state 450 receive no further processing.

A sales leads 70 in the state of needs fulfillment 840 is a sales lead 70 that requires additional materials before the sales lead 70 can actually be assigned. For example, a specific sales lead 70 could require additional sales information, product information, service and warranty information, and the like before a sales agent 250 could act to fulfill sales lead 70.

Sales lead 70 in assigned state 460 can be reassigned 460, leaving the sales lead 70 in the assigned state 460, or it can be noted as an invalid sales lead 70 and enter into the pending bad sales lead state 860. It is informative to note that reassignment is a generic term with a broad enough definition to include non-sales entities. For example, a sales lead 70 could be reassigned 460 to an entity that would re-evaluate the sales lead 70.

A sales lead 70 stays in the assigned state 460 until a sales entity 250 (most often a sales representative or sales agent 250) receives assigned sales lead 70. It is informative to note that the act of receiving a sales lead 70 places the sales lead 70 into the state of being received 520 while also imposing a state and requirements upon the receiving actor. For example, receiving a sales lead 70 imposes various requirements and activities upon the receiving sales entity 250. Changing the state of a sales lead 70 from assigned to received 520 also changes the major state of the sales lead 70 from that of sales lead state 800 to assigned state 810. Sales lead 70 can transition from being received 520 to that of waiting for follow up 530 or to that of being assigned to a distributor 500.

A received 520 sales lead 70 can also enter into a state of waiting on voc 540. The normal transition is for a sales lead 70 to exit from waiting on voc 540 and enter into the received voc state 570. Other possible states, though not shown, include entering into a no response state, typically after a waiting period, no voc possible, no voc needed, and the like. Normally, a sales lead 70 transitions to being satisfied 580 after receiving a voc feedback.

A received 520 sales lead 70 can also enter into the state of overdue 830 after an overly long period of non activity upon the respective sales lead 70. In this example implementation, the sales lead 70 in a state of overdue 850 can be revived through being re-marked received 520.

Once assigned to a distributor 500, a sales lead 70 can transition to the major state of being in a distributor assigned state 560 through the distributor 500 assigning 590 the sales lead 70. The typical scenario for this is where a distributor 500 assigns the sales lead 70 to a distributor representative (a sales agent 250). A distributor 500 assigned 590 sales lead 70 can also enter into a state of waiting on voc 540.

Other typical states include entering into a no response state 600 after a period of delay or a state of denied 610 by the sales representative. Usually, a no response state 600 and a denied state 610 cause the sales lead 70 to revert back to a received state 520 with the owner being a manufacturer's sales agent 250.

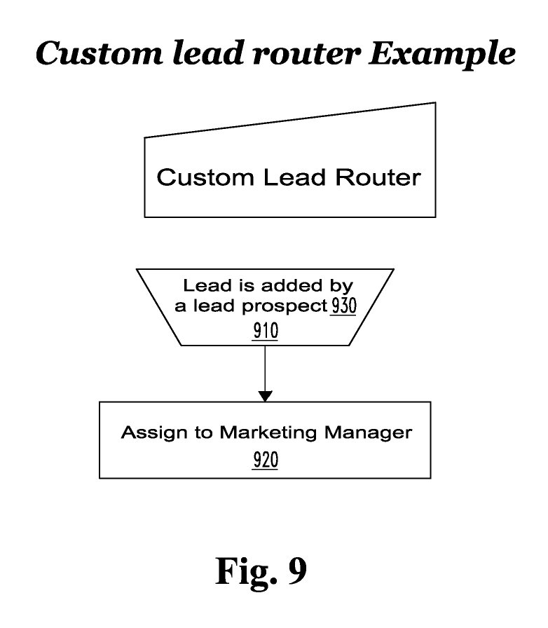

FIG. 9 illustrates a possible custom sales lead router process 900 for the example manufacturing and product distribution depicted in FIG. 6. In process step 910, a sales lead 70 is added by a sales lead prospector 930. Examples of sales lead prospectors 930 include commissioned sales lead finders, automated contact and response systems, web based interaction systems, and the like. In this example, an added sales lead 70 is routed to a marketing manager in process step 920.

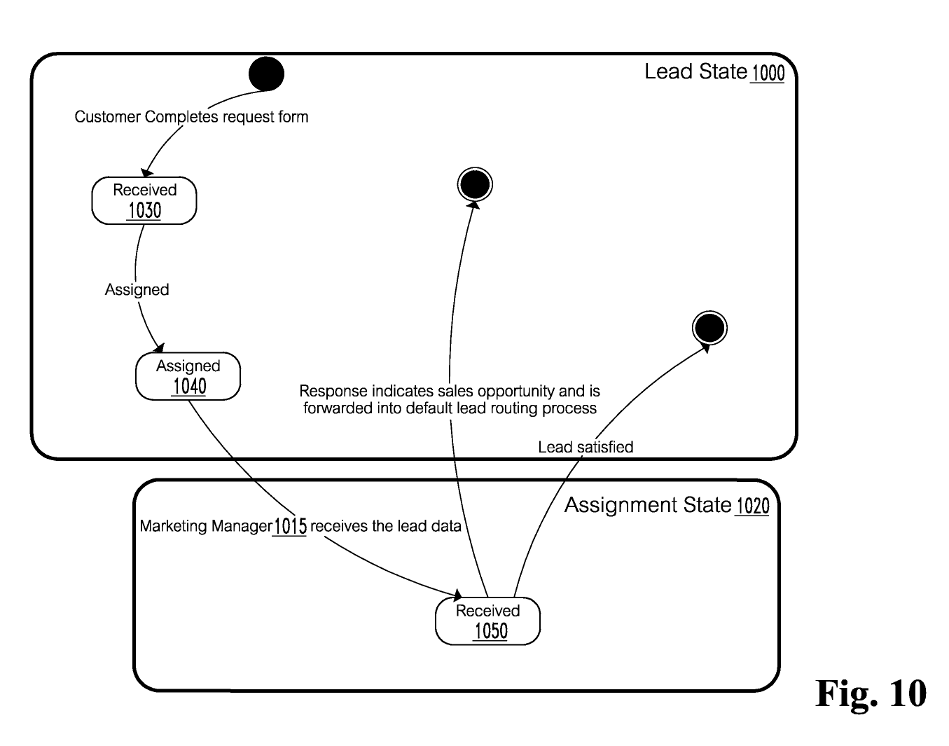

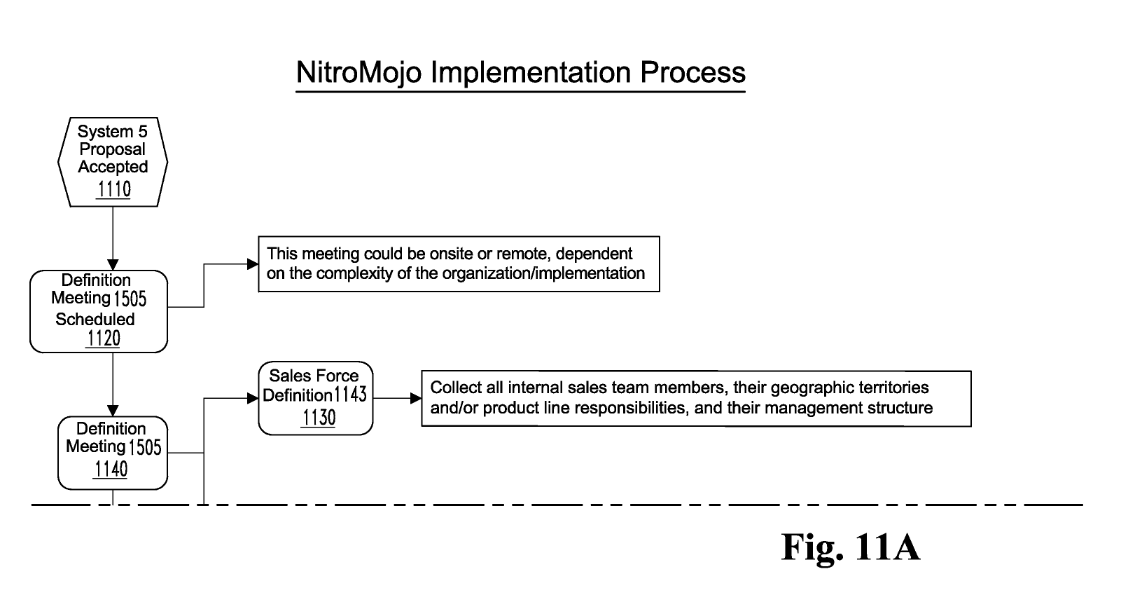

FIG. 10 illustrates a possible custom sales lead management process 1000 for the example situation depicted in FIG. 6. In this example, the process 1000 represents an amount of pre-processing to screen out the nonproductive sales leads 70 that tend to occur from large scale email advertising campaigns. However, it is informative to note that that while process 1000 represents pre-processing to screen out nonproductive sales leads 70, other possible unique and/or specialized processing is possible. For example, process 1000 could have been configured to effect net promoter scoring (NPS), market research study, potential customer survey, brand awareness survey, and the like.

The process 1000 consists of two major states, initial sales lead state 1010 and an assigned state 1020. In the initial sales lead state 1010, a sales lead 70 enters into the system, the sales lead's 70 state becomes received 1030. Assigning the sales lead 70 causes the sales lead's 70 state to change to assigned 1040. However, it should be noted that in this example the assignment is actually to a marketing manager 1015. The market manager 1015 further reviews sales lead 70 to ensure that the sales lead 70 is worth the effort of following up. Once received 1050 by the marketing manager 1015, sales lead 70 is either discarded or put into the normal processing depicted in FIG. 8.

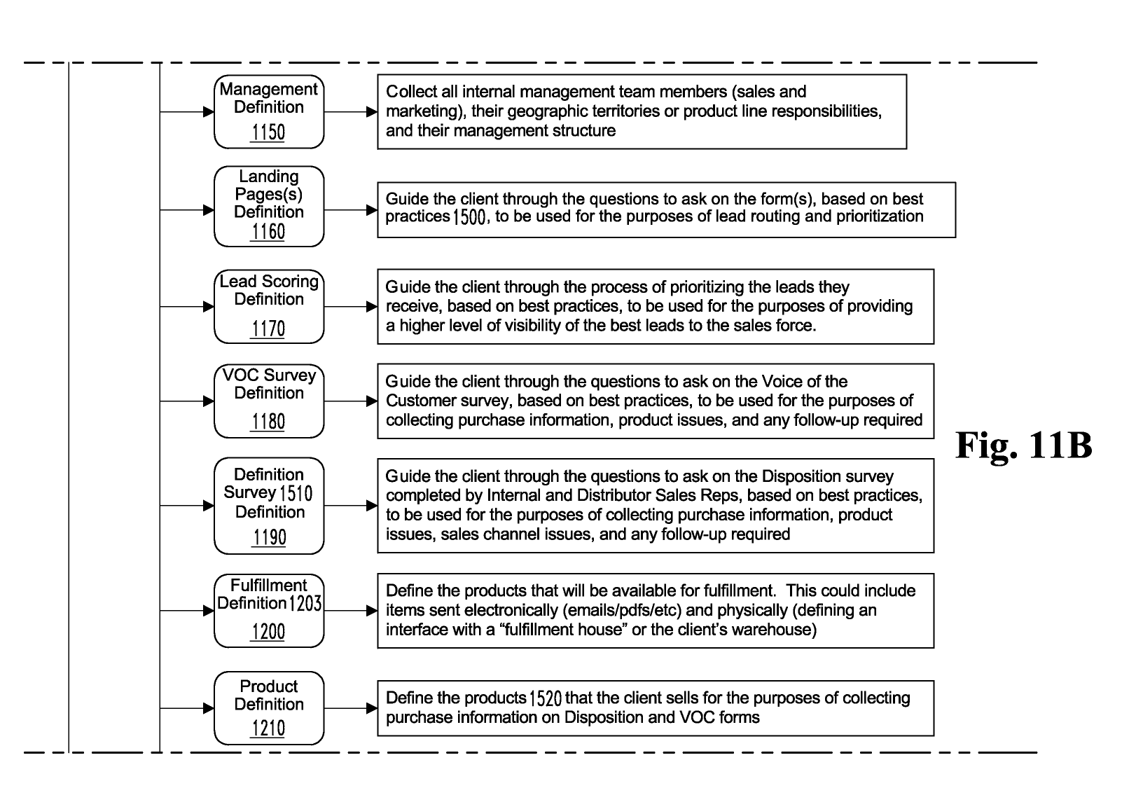

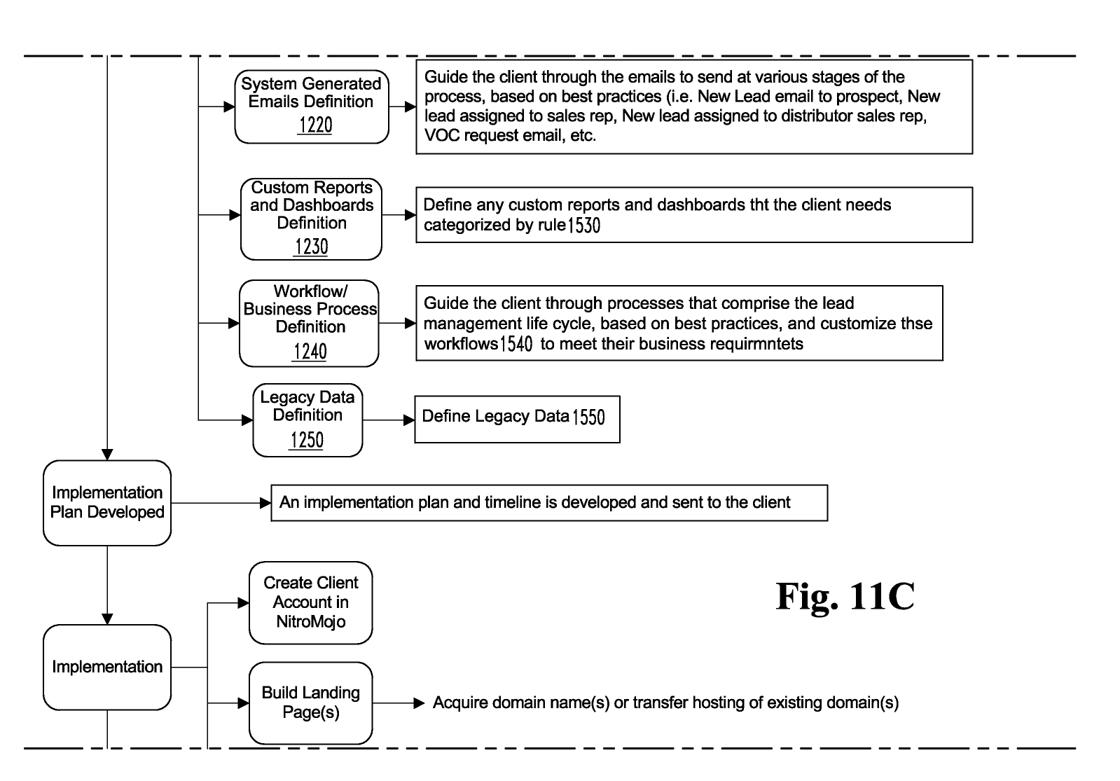

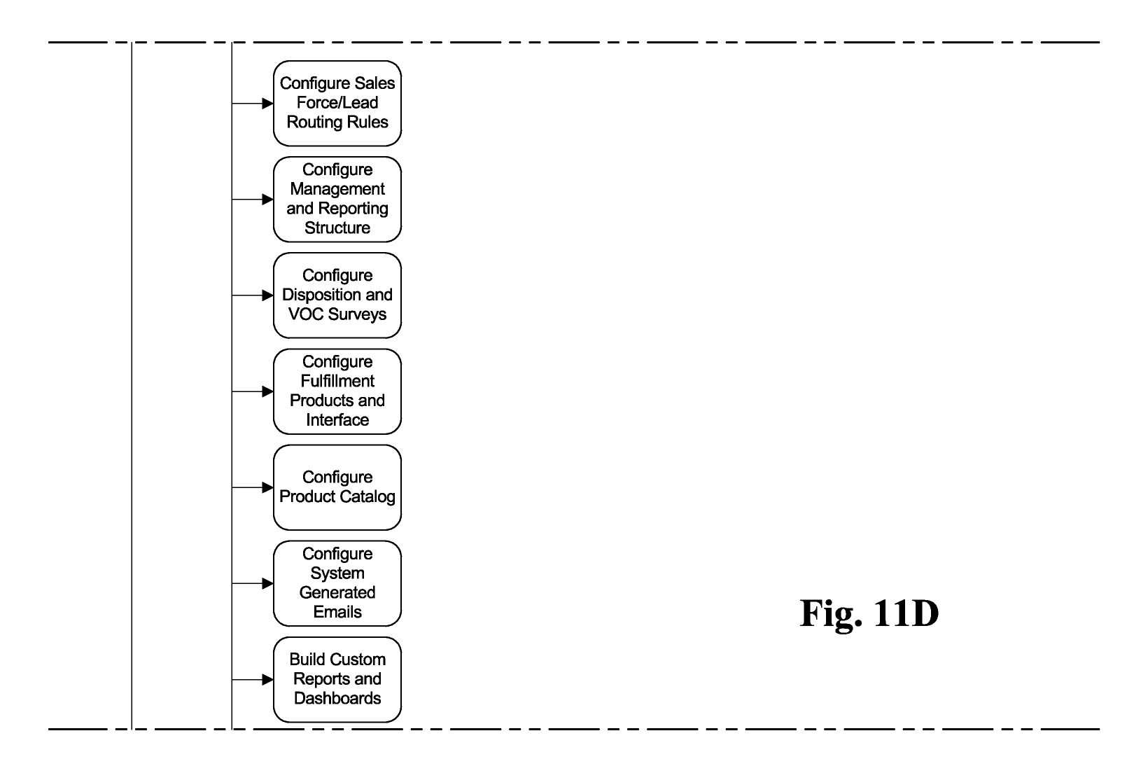

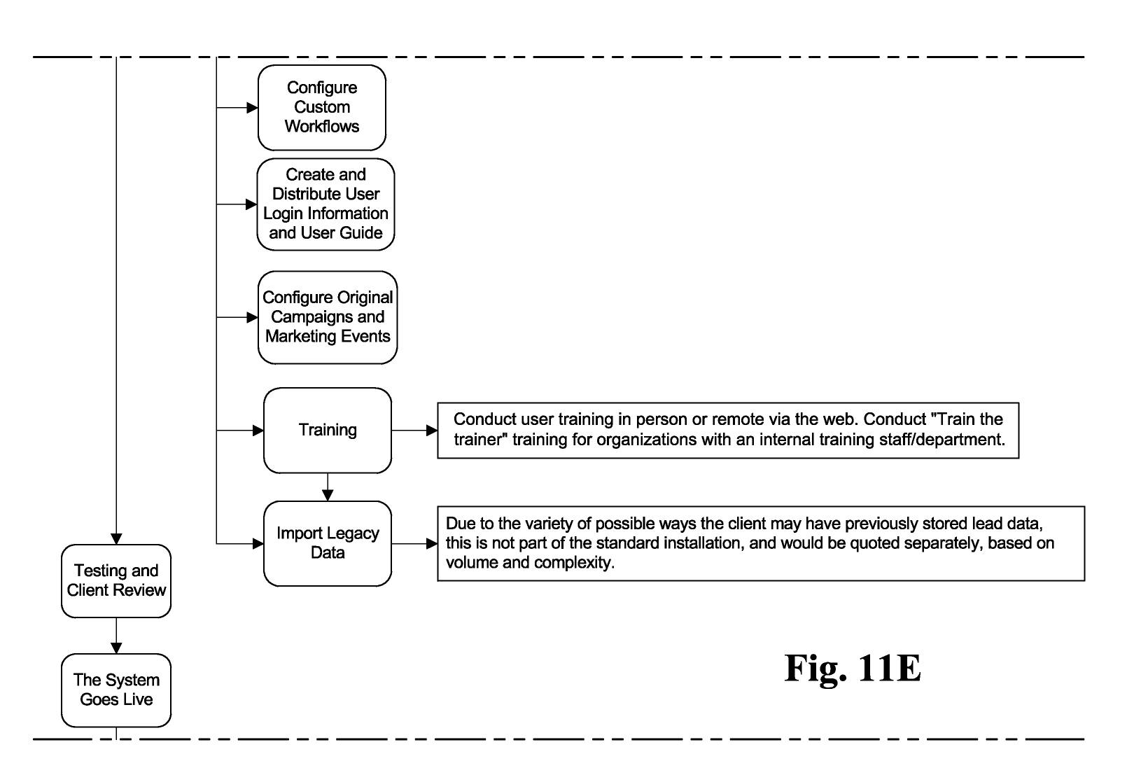

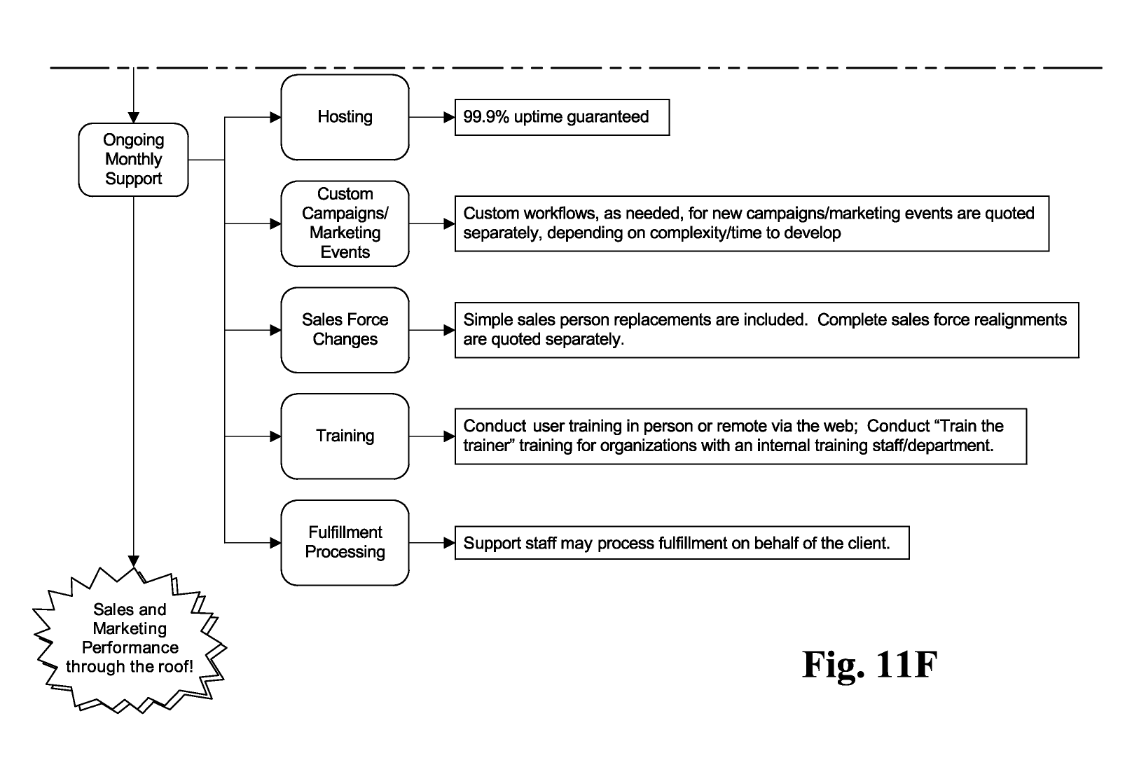

FIG. 11 illustrates an example installation of a customizable system 5 for the automatic management and evaluation of business lead creation and development. It should be noted that while shown and discussed in a linear sequence, the various processes associated with an installation of a customizable system for the automatic management and evaluation of business lead creation and development often occur in parallel or in different sequences. Typically, the process 1100 begins with process step 1110 where company 10 accepts a proposal for the system 5 installation. Next definition meeting schedule 1120, is operated to establish a timeline for all the upcoming definitional meetings. A definition meeting 1505 is a generic term representing the gathering of definitions, processes, process flows, requirements, and the like with respect to a specific functional area of the company 10. For example, process step sales force definition 1140, contained within process step 1130, is a meeting where information such as names, geographic responsibilities, the management and the like of the sales agents are gathered. Management definition 1150 and legacy data definition 1250 are similar to sales force definition 1143 in that they are meeting where the respective to the meeting information is gathered.

Landing page definition 1160 is slightly different than other definitional meetings. The landing page definition 1160 meeting also guides the company though the process of mapping a collection of lead 70 distinguishing characteristics of a lead 70 into an initial lead 70 routing and prioritization process. The starting point of the meeting is normally a best practices 1500 collection of information gathering questions. A typical later implementation of the initial lead 70 routing and prioritization process is through a collection of information gathering questions upon a lead collecting or entering web page. Example other possible implementations of an initial lead 70 routing and prioritization process include using post cards, telephone interviews, survey-like forms, and the like.

Lead scoring definition 1170, voc survey definition 1180, disposition survey definition 1190, fulfillment definition 1200, product definition 1210, system generated emails definition 1220, custom reports and dashboards definition 1230, workflow business process definition 1240, and legacy data definition 1250 are all implementation process steps similar to Landing page definition 1160 in that the afore mentioned processes all utilize a collection best practices 1500 as the starting point for their information or component of implementation. Lead scoring definition 1170 is responsible for determining a company's 10 best means of prioritizing leads 70 based upon a lead's 70 criteria. Typically a lead's 70 characterizing information is gathered through a device resulting from landing page definition 1160. Voc survey definition 1180 is responsible for determining a company's 10 best voc 540 instruments, including both form and content thereof. Disposition survey definition 1190 is responsible for determining a company's 10 best disposition 1510 instruments, including both form and content thereof. A disposition 1510 is an information reporting instrument typically completed by internal or external to the company sales agents 250 for the purposes of collecting purchase information, product issues, sales channel issues, follow-up information, and the like. Fulfillment definition 1200 is responsible for defining the company's 10 means of fulfilling a lead 70. Fulfillment 1203 is a broad term and encompasses providing product delivery, product information, general sales information, and the like. Product definition 1210 is responsible for defining the company's 10 products 1520. While listed separately, large information overlap often enables product definition 1210 to be done at the same time as disposition definition 1190 and voc survey definition 1180. System generated emails 1220 is responsible for responsible for defining the company's 10 automated emails to be sent as part of the company's 10 customizable system for the automatic management and evaluation of business lead 70 creation and development. Custom reports and dashboards definition 1230 is responsible for determining the informational needs of the various roles 1530. Workflow business process definition 1240 is the process responsible for developing the work flow 1540 representative of a lead's 70 lifecycle. The work flow 1540 is initially mapped according to best practices 1500 and is further refined to represent the company's 10 current or desired work flow 1540. Legacy data definition 1250 is the process responsible for defining legacy data's 1550 existence within the resulting customizable system for the automatic management and evaluation of business lead 70 creation and development.

After the many definitional and requirement gathering activities, the process of implementing the system continues with the planning of the implementation of the system. The actual implementation of the customizable system for the automatic management and evaluation of business lead 70 creation and development follows the planning of the implementation. The general sub processes are shown in FIG. 11. There are also the processes for testing and client review, going live with the system, and ongoing monthly support; all of which are shown in FIG. 11 for the purposes of completeness but not described here.

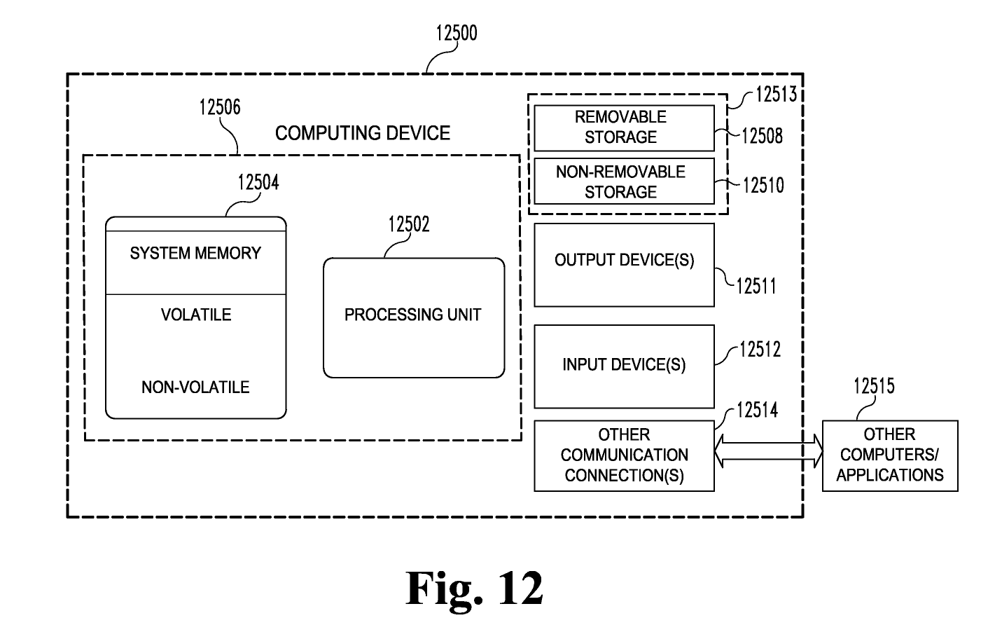

FIG. 12 is a diagrammatic view of a computer system 12500 of one implementation. As shown in FIG. 12, an exemplary computer system to use for implementing one or more parts of the computer system 12500 includes a computing device 12506. In its most basic configuration, computing device 12506 typically includes at least one processing unit 12502 and at least one memory unit 12504. Depending on the exact configuration and type of computing device, memory unit 12504 may be volatile (such as RAM), non-volatile (such as ROM, flash memory, etc.) or some combination of the two. This most basic configuration 12506 is illustrated in FIG. 12.

Additionally, computing device 12506 may also have additional features and/or functionality. For example, computing device 12506 may also include additional data storage 12513 (removable and/or non-removable) including, but not limited to, magnetic or optical disks or tape. Such additional storage is illustrated in FIG. 12 by removable storage 12508 and non-removable storage 12510. Computer storage media includes volatile and nonvolatile, removable and non-removable media implemented in any method or technology for storage of information such as computer readable instructions, data structures, program modules or other data. Memory unit 12504, removable storage 12508 and non-removable storage 12510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 12506. Any such computer storage media may be part of computing device 12506.

Computing device 12506 typically includes one or more communication connections 12514 that allow computing device 12506 to communicate with other computers/applications 12515. Computing device 12506 may also have input device(s) 12512 such as keyboard, mouse, pen, voice input device, touch input device, etc. Output device(s) 12511 such as a display, speakers, printer, etc. may also be included. These devices 12511, 12512 are well known in the art and need not be discussed at length here.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

What is claimed is:

1. A method for measuring the performance and utilization of a marketing campaign consisting of:
a) tracking responsiveness of a plurality of distribution channels to respective leads, wherein each respective distribution channel has at least one component;
b) measuring a return on investment for a marketing campaign;
c) managing the respective distribution channels;
d) evaluating performance of the marketing campaign; and
e) evaluating performance of the at least one components of the respective distribution channels on the leads;
wherein the marketing campaign includes at least one marketing event;
wherein the leads are attributed to the at least one marketing event; and
wherein the leads are associated with a voice of customer evaluation.

2. The method of claim 1 wherein the leads are assigned an actionable value based upon a customer profile.

3. The method of claim 2 wherein actionable valued leads are distributed into the respective distribution channels based upon the assigned actionable value.

4. The method of claim 2 wherein actionable valued leads are distributed to specific distribution channel components based upon a customer profile.

5. The method of claim 1 wherein a voice of customer performance evaluation is uniquely associated with the at least one marketing event.

6. The method of claim 2 wherein a voice of customer performance evaluation is generated for each actionable valued lead with an actionable value greater than a predetermined action threshold.

7. The method of claim 1 wherein the components of the respective distribution channels are associated with a voice of customer performance evaluation.

8. The method of claim 1 further comprising:
f) means for receiving voice of customer performance evaluation data;
g) at least one work product associated with a set of work flow processes; and
h) at least one customer profile associated with the work product;
wherein the voice of customer performance evaluation data is used to evaluate the return on investment for a marketing campaign;
wherein the marketing campaign is for the at least one work product; and
wherein the voice of customer performance evaluation data is associated with the at least one work product.

9. A method of measuring the effectiveness of a lead creation and handling process consisting of:
a) receiving a budget;
b) receiving at least one opportunity lead;
c) associating a voice of customer performance evaluation to the at least one opportunity lead;
d) distributing the at least one opportunity lead into distribution channels based upon an actionable value;
e) tracking the handling of the at least one opportunity lead by the distribution channels;
f) measuring performance of the distribution channels with respect to the at least one opportunity lead;
g) receiving the voice of customer performance evaluation response; and
h) outputting metrics;
wherein the marketing campaign includes a marketing event;
wherein the voice of customer performance evaluation is associated with the marketing event; and
wherein the at least one opportunity lead is associated with the marketing event.

10. The method of claim 9 wherein the metrics are based upon the budget, a total of the at least one opportunity leads, the performance of the distribution channels, and a voice of customer performance evaluation response.

11. The method of claim 9 wherein the metrics are selectively viewable based upon a viewer's role.

12. The method of claim 9 wherein the voice of customer performance evaluation response is received through an internet web interface.

13. The method of claim 9, further comprising the steps of:
i) after (a) and before (e), receiving a set of work flow processes associated with a work product;
wherein elements of the set of work flow processes are subsequently mapped to components of the distribution channels responsible for their respective execution.

14. The method of claim 9, further comprising the steps of:
j) after (a) and before (d), receiving a customer profile;
k) after (a) and before (d), deriving the actionable value based upon a customer profile; and
l) after (a) and before (d), prioritizing the at least one opportunity lead based upon the actionable value.

15. The method of claim 9 further comprising the steps of:
m) after (e) and before (f), sending opportunity lead action prompts to non responsive components of the distribution channels.

16. The method of claim 9 further comprising the steps of:
n) after (e) and before (g), redistributing the at least one opportunity lead into the distribution channels after insufficient response.

17. A method for evaluating the performance of a marketing event and manage lead response consisting of:
a) receiving at least one lead;
b) receiving at least one voice of customer feedback;
wherein the at least one voice of customer feedback is associated with the at least one lead;
c) distributing the at least one lead into a distribution channel based upon an actionable value;
d) evaluating processing of the at least one lead by the distribution channel;
e) refining the processing of the at least one lead by the distribution channel.

18. The method of claim 17 wherein the at least one lead can be reclaimed from the distribution channel and distributed to a second distribution channel.

19. The method of claim 17 wherein the at least one lead originates from a marketing event.

20. The method of claim 17 wherein the actionable value is a derived value based on attributes of the at least one lead.

21. The method of claim 17, further comprising the steps of:
after (c) and before (d), tracking the distribution channel's processing of the at least one lead;
f) after (d) and before (e), outputting metrics;
g) after (d) and before (e), identifying inadequate processing of the at least one lead by the distribution channel.

22. The method of claim 17 wherein the actionable value is further refined in response to a customer profile.

23. The method of claim 20 wherein the voice of customer feedback is received through an internet web interface.

24. The method of claim 17 wherein the voice of customer feedback is received as part of a product registration.

25. The method of claim 17 wherein the at least one lead is prioritized based upon a customer profile; and
wherein the customer profile is associated with the at least one lead.

26. The method of claim 17 wherein the metrics are based upon a budget associated with the marketing event, a total of the at least one leads originating from the marketing event, the performance of the distribution channels, and the voice of customer feedback.

27. The method of claim 17 wherein the metrics are selectively viewable based upon a viewer's role.
